(19) United States
(12) Patent Application Publication
(10) Pub. No.: US 2013/0041776 A1
(43) Pub. Date: Feb. 14, 2013

(54) CASH PAYMENT APPARATUS, SYSTEM AND METHOD

(71) Applicant: Robert Peter SCHUNEMANN, Odenton, MD (US)

(72) Inventor: Robert Peter SCHUNEMANN, Odenton, MD (US)

(73) Assignee: Robert Peter SCHUNEMANN, Odenton, MD (US)

(21) Appl. No.: 13/567,290

(22) Filed: Aug. 6, 2012

Related U.S. Application Data
(60) Provisional application No. 61/522,333, filed on Aug. 11, 2011.

(51) Int. Cl. G06Q 30/06

(52) U.S. Cl. 705/26.41; 705/26.1

(57) ABSTRACT

Using communications enabled devices or computers, Cash Payment System (CPS) buyers authenticate and authorize payment to sellers. Sellers identify themselves to the buyer and the buyer controls the payment process.

### CROSS REFERENCE TO RELATED APPLICATIONS

This application claims priority to provisional application No. 61/522,333, filed on Aug. 11, 2011. The entire contents of this earlier filed application are incorporated herein.

### BACKGROUND

1. Field

Embodiments relate to an electronic cash payment apparatus, system and method in which buyers authenticate and authorize payment to sellers.

2. Description of the Related Art

Cash can be currency, or an encrypted digital file within a secure banking system. Currency can be freely exchanged between people or used to pay for a commercial purchase. However, freely moving cash electronically is more complicated than moving currency.

Starting with the impress charge card, at one time, funds were internal to the merchant. Various technologies and business groups have been inserted into what has become a universal revenue generating payment system. Credit card companies, working with banks, clearing houses, independent card purveyors and processors now offer many benefits that appear free to card users, but are a substantial burden on sellers where nominal fees are 2%. While “rewards cards” charge merchant's fees up to 5%.

Payment cards and checks, as used today, have no intrinsic authorization mechanism. Credit card authorizations are often just a banker's statement that sufficient funds exist, while overlooking the issue of authentication. Possession of a payment card, or the card number, is too often treated as evidence that the rightful owner is using the card. Zip codes are not intrinsic security. A signature captured at a point of sale (POS) terminal is not usually matched against a reference at the time of purchase. A check can be tendered, goods received, and subsequently rejected as a fraud, resulting in expensive and time consuming payment recovery resolution issues.

One reason fraud frequently goes undetected is that credit card payments and checks silently remove funds from bank accounts, under the control of third parties, without the awareness of the account holder.

Most recent electronic and wireless payment approaches deal with portions of the transaction problem set. They lay no groundwork for a broad, holistic system to encompass most payment venues and their related requirements.

### SUMMARY

One embodiment includes a cash payment method. The cash payment method includes receiving, by a client buyer, a seller identification and transaction data from a seller in a transaction. The cash payment method further includes sending, by the client buyer, an authorization to the seller. Upon receipt of the authorization by the seller, the transaction is completed. In an embodiment, the method may further include automatically sending, by the client buyer, a pay command to the cash payment system (CPS) bank of the client buyer, the pay command directing the CPS bank to pay the seller.

Another embodiment is directed to an apparatus including at least one processor and at least one memory. The at least one processor and the at least one memory are configured to control the apparatus to receive a seller identification and transaction data from a seller in a transaction, and send an authorization to the seller. Upon receipt of the authorization by the seller, the transaction is completed.

Another embodiment may include a computer program embodied on a non-transitory computer readable medium. The computer program is configured to control a processor to perform a process including receiving, by a client buyer, a seller identification and transaction data from a seller in a transaction, and sending, by the client buyer, an authorization to the seller. Upon receipt of the authorization by the seller, the transaction is completed.

### BRIEF DESCRIPTION OF THE DRAWINGS

For proper understanding of the invention, reference should be made to the accompanying drawings, wherein:

FIG. 1A illustrates a block diagram of a credit card payment process;

FIG. 1B illustrates an example of block diagram of a cash payment system (CPS) according to one embodiment;

FIG. 1C illustrates another example of a cash payment system (CPS) according to an embodiment;

FIG. 2A illustrates a block diagram of a CPS transceiver interface module according to one embodiment;

FIG. 2B illustrates a block diagram of a vending machine interface according to one embodiment;

FIG. 2C illustrates a block diagram of an interface between a client buyer and CTA, according to one embodiment;

FIG. 3A illustrates an example of a hitch hiker mode according to an embodiment;

FIG. 3B illustrates an example of transmitted multi-choice vending according to one embodiment;

FIG. 4A illustrates an example of a data card according to an embodiment;

FIG. 4B illustrates a flow diagram of data card data flow according to one embodiment;

FIG. 5 illustrates a flow diagram of NFC data flow according to one embodiment;

FIG. 6 illustrates a block diagram of a CPS interface module according to one embodiment;

FIG. 7A illustrates a block diagram of bar code reader CB identification according to an embodiment;

FIG. 7B illustrates an example of a matrix code identification according to an embodiment;

FIG. 8 illustrates a block diagram of CPS terminal modules according to one embodiment; and

FIG. 9 illustrates a block diagram of the CPS according to an embodiment.

### DETAILED DESCRIPTION

It will be readily understood that the components of the present invention, as generally described and illustrated in the figures herein, may be arranged and designed in a wide variety of different configurations. Thus, the following detailed description of the embodiments of a method, apparatus, system, and computer-readable medium, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

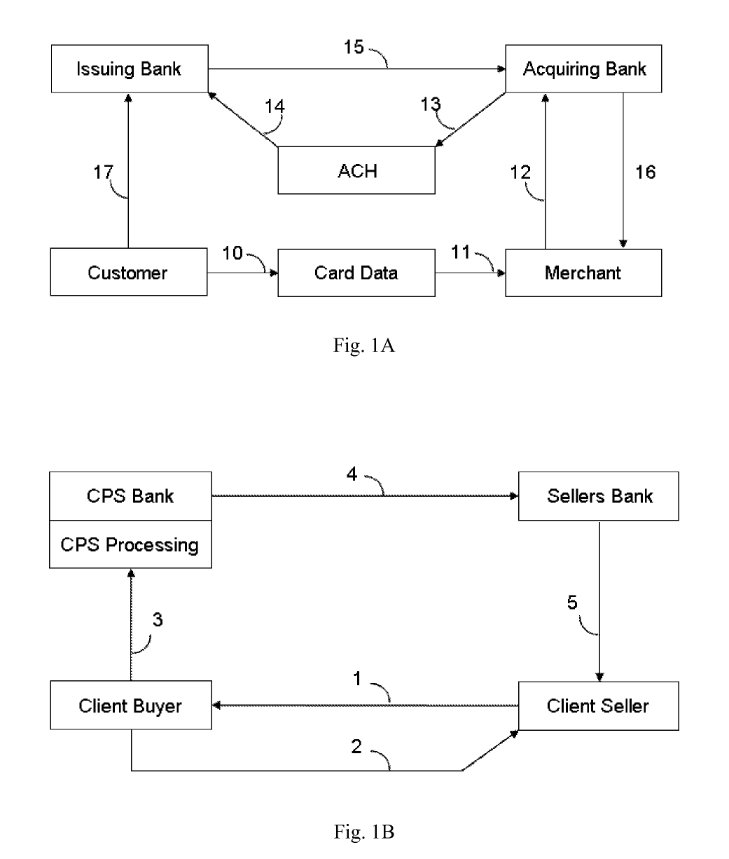

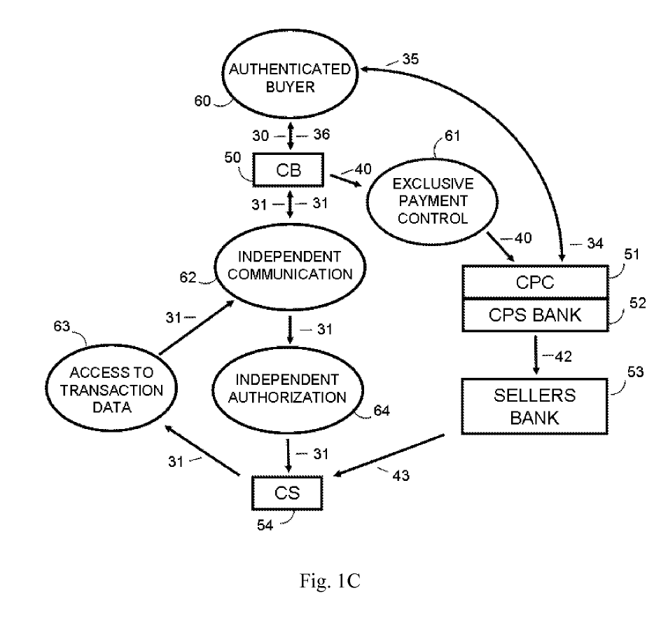

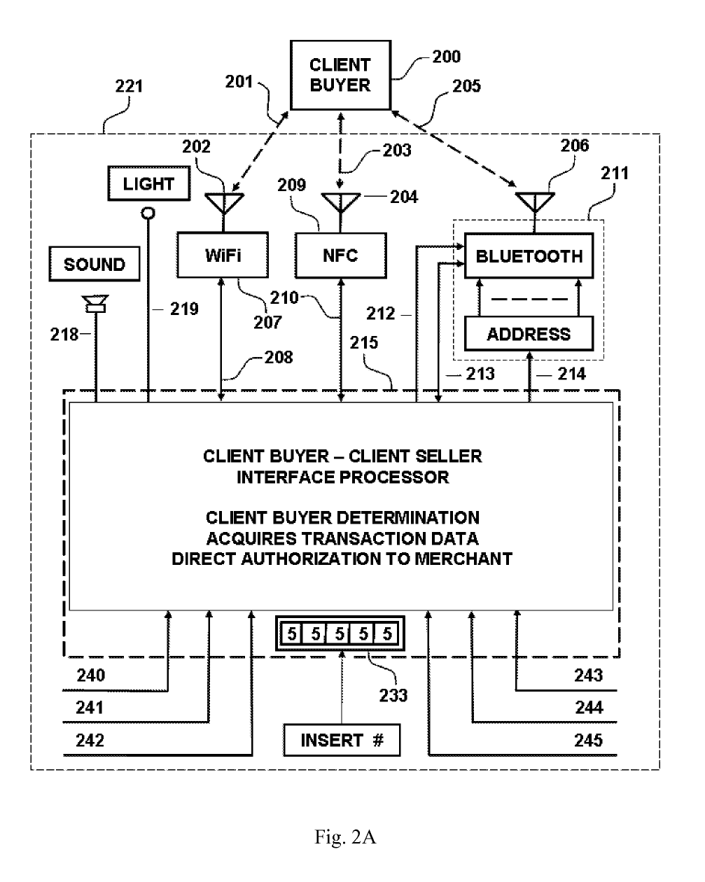

FIG. 1A illustrates an example of a block diagram depicting a credit card processing method. Authorization and payment transactions are illustrated in the context of seven electronic communications links within the block diagram depicted in FIG. 1A. “Merchant” refers to a payment card reader, such as a point of sale (POS) terminal, that may include a printer, a cash register and a back office processor.

A customer presents items at a check out terminal 10 to purchase the items with a credit card. When swiping a credit card, encrypted card data is transferred from the reader to the merchant's POS terminal 11; provision is made to include the dollar amount and other relevant transaction data. As an authorization request, this data is forwarded to the merchant's (acquiring) bank 12. The merchant's bank composes a transaction data message and forwards it to the Automated Clearing House (ACH) specified on the credit card 13, where the status of the credit card is assessed, and a request message is sent to the customer's (issuing) bank 14 to determine if there are sufficient funds. If there are sufficient funds, the issuing bank forwards an authorization code 15 to the merchant's bank, which then forwards it 16 to the merchant for printing and release of the customer.

In practice, there are variations of the model illustrated in FIG. 1A. Clearing houses may send an authorization message under some circumstances. An encrypted card reader message may be routed directly to a remote company back office over the Internet. In some instances, the credit card reader sends encrypted data directly to the credit card clearing house, which forwards the request for an authorization to the issuing bank. Endpoints for decrypting the credit card reader encryption may be a small merchant's bank, a merchant's retail processing center, a gateway or a credit card company clearing house, and are addressed as provisioning. These factors will require some variations in how CPS elements are deployed and how they interface in order to integrate with existing operations, and still perform the functions of buyer authorization and payment.

There are numerous fees charged in relation to a transaction. The Automated Clearing House (ACH) charges a fee between $0.12 to $0.44 per $100 transaction. For large transactions the issuing bank can receive $1.00 from the credit card company. The issuing bank can charge $0.50 for disbursing the funds. The issuing bank sends $98.50, minus the ACH processing fee, to the acquiring bank. The acquiring bank can charge $0.50 to receive the funds. The merchant receives $98.00 minus the ACH fee. By contrast, DTCC, the major financial sector payment transaction clearing house, clears each transaction for a penny. The high cost of credit card processing includes the cost of fraud due to inadequate authentication techniques, multiple participating profit centers along the communication chain and high profits. For example, a typical charge fee for a $400 credit card sale at a tire merchant, is $6.50.

Issuing and acquiring banks in the credit card business become quasi-owners of the credit card business. Today the two major card brands use independent banks, and the two smaller card brands are their own banks. The credit card company business, itself, earns revenue from fees charged to member banks and operating an extensive network of clearing and security services. There are also independent clearing houses that service credit card transactions. Any single network processor is constrained from “owning” the communication link that services credit card transactions, or from owning all the processing. When using the Internet to pass traffic it is practical to create a credit card Virtual Private Network, that reduces attacks, while enabling other traffic over that access such as a merchant's Virtual Private Network or any other Internet protocol traffic. A VPN network operated by one credit card processing company must forward card reads from other payment card companies to the appropriate clearing house or bank per the issuer identification number contained on every card.

The cash payment system (CPS), according to one embodiment, provides a reliable system that enables individuals, using superior authentication techniques, to make authorizations directly to sellers at the time of purchase using, for example, their mobile devices or fixed computers, and to exclusively control the payment of funds from their CPS Bank account to the merchants bank account. CPS communications and systems are configured to operate securely.

It is noted that, in this disclosure, the term “smartphone” is used to represent any mobile device able to communicate. The terms merchant and seller are used interchangeably.

According to an embodiment, the CPS bank only moves funds out of an owners account by the conscious action of the authenticated owners' client buyer; accordingly, the authenticated owner must authorize the CPS bank to move money out of that account. This is unlike conventional banks, which use inadequate authentication methods to honor several different methods by which others may remove funds from a person's account.

Embodiments enable a buyer to authenticate and authorize the transfer of funds to the seller at the point of sale, in seller environments such as vending, access control, dispensing, desktop, web and in-store purchasing, and thereby enable the buyer to control the payment transaction without third parties, such as automated clearing houses or an authorization from an issuing bank. Thus, embodiments enable mobile payments without a fee to use a specific merchant's payment system and without being constrained to use only that merchant's electronic system. CPS is a holistic solution for universally making electronic payments more securely and at lower cost.

Some sellers offer free WiFi, and prefer that as a payment communication system. Others may avoid new technology, so it is important to show that the buyer directly controls the payment. Some are without commercial communications. Some operate with only cell phone. Some operate access terminals or various types of vending machines, such as item or indeterminate quantity sales. Some merchants sell over the Internet and, therefore, payments to Web purveyors are important. The Cash Payment System (CPS), according to certain embodiments, provides a system of payment that can be used to purchase items or services from all types of merchants or sellers.

In one embodiment, smartphones, or other computers or tablets, may be used as client buyers to buy on behalf of their owners. A Client Buyer (CB) enters a secure community to authenticate and authorize payment transactions to client sellers (CS). A CPS CB's authorization provided directly to a merchant states that the CB's CPS bank account will pay to seller's bank, and then subsequently pays to seller's bank the appropriate amount associated with the transaction. In one embodiment, the CPS provides secure text communications between users to facilitate transactions and secure personal communications between members.

Embodiments provide numerous CPS management and security functions such as a finger print, voice print or image match as part of a challenge/response regime, among others, to authenticate that the user of a CB is the rightful owner. Clients may be multipurpose communication enabled computers such as smartphones, tablets, laptops, desktops and any other device. Typical clients are Client Buyers (CB), Client Sellers (CS), Client Vending Machine, Client Service Provider, Client Venue Access, etc.

In one embodiment, in order to make a CB purchase, a CS is electronically identified to the CB, and the CB authenticates and authorizes the transaction directly to the CS, and instructs payment by sending a “PAY” command to the CPS Processing Center (CPC). CPS executes the subsequent payment transaction. Typical communications media may include the internet protocol over WiFi, cellular dial-up connections, cellular data service, Bluetooth, Near Field Communication (NFC), or via a merchant's CPS Transceiver Interface Module (CTIM).

Client sellers may operate as service providers for a variety of business building services such as advertising, rewards, loyalty, points, discounts, ads and others. CBs may employ sub-rosa owner/user tests and, for a high fraud score, includes overt challenge/response biometric analysis of the users voice print, and, if needed, their image as compared with a reference file.

CBs can manage accounting data in at least two ways. For example, they can download a dollar amount that they are allowed to spend, keep records of, and report to the CPS, or they may command the payment of the actual funds in the CPS bank that are represented by the accounting records on the CB.

Current payment systems have problems related to fraud. Embodiments of the invention are designed to minimize fraud due to the compromise of personal information, and other situations where fraud is not noticed because it is occurring outside the account owner's span of control. According to an embodiment, CPS client buyers do not just promise to pay, they are the only entity able to execute the “PAY” command. Moving money out of the clients CPS bank account occurs only under the conscious control of the CPS bank account owner by use of the CB.

It should be noted that issuing an electronic pay instruction to a customer's conventional bank is very different from issuing a CB “PAY” command to a CPS bank according to embodiments of the invention. A conventional bank enables other entities to remove funds from their account (checks, other charges, etc.). Conventional bank account owners are exposed to other entities that may be fraudulent. At the time of a fraudulent withdrawal, that account owner may not be aware that a transfer is occurring.

According to an embodiment, issuing a CB “PAY” command, which has owner authentication built in, is the only way to remove funds from their account. No personal information, such as credit card number, a person's name, or their bank account (as is used by other electronic payment methods and instructions) is transmitted by the CPS in the execution of payment transactions. Unlike other systems, CPS is secure at several levels. CPS reduces the need for automated teller machines, to carry checks, use payment cards or carry currency.

For example, in one embodiment, a CB may be provided with a “PAY” button which is selected to proceed with the purchase. There may also be provided a button that enables the CB to “Decline.”

As another example, the CB may select “PAY”, and, after that, the seller refuses to turn over the purchased items to the customer. While this may not be an issue for the CPS to resolve, or even a reason to block the subsequent payment, embodiments provide a button that enables the CB to indicate “Seller reneges.” Once the “PAY” button is selected the seller is paid regardless of subsequent disagreement. However, the “Seller reneges” button alerts the CPS that this may be an unreliable seller, so it becomes an issue for CPS to resolve with the seller regarding the sellers CPS membership. The customer/seller/renege issue can be left to the buyer and seller to resolve, and CPS avoids the problem of canceling a transaction and reinstating the previous state, as sometimes happens with checks and credit cards.

If there are insufficient funds on the CB, a “PAY” button is not displayed. In this situation, the buyer may transfer additional funds from their CPS bank account to their CB. When sufficient funds are available on the CB, once a client buyer selects “PAY,” the funds will transfer to the merchant's bank. Any subsequent problems are not the province of the CPS to resolve, such as a returned product. The merchant has obtained a cash payment, so to resolve a returned product issue the merchant must return cash to the customer.

In some embodiments, a CB user may enter the dollar amount for the transaction manually. While this goes against the precept of gathering all of the transaction data electronically to avoid human error, for a very light weight early transitional mode this may provide a cost effective solution. As a result, embodiments do not interfere with existing payment systems—and parts of those may be used, initially, to support CPS.

One embodiment uses a CPS Data Card (CPS DC) with a magnetic strip and NFC tag; both have the same data, but the CPS DC may have coding that distinguishes it from the NFC tag in a CB. By swiping the CPS DC, the merchant's transaction data is added to the CB data on the card and the message is sent to the merchant's bank, and from there to the facility indicated by the routing address in the card. In the case of the CPS DC, the message arrives at the CPS Bank, without using resources of a credit card company. The CPS bank forwards it to the CPS processing center (CPC). The CPC sends a message to the CB stating the amount and merchant. If correct, the CB “PAY’ button is selected, and a PAY command message is sent to the CPC. It should be noted that this is different from a situation where a third party is already in a position to pay and only seeks to determine if the merchant and dollar amount are correct. After receiving the pay command message, the CPC forwards an authorization code to the CPS bank which sends the authorization to the merchant's bank. This is forwarded to the merchant's back office and then to the merchant's terminal for printing and release of the customer. Payment may occur subsequently as a separate operation.

If either the CPS DC or the smartphone are stolen, it will not be possible to execute a payment. If the CB and CPS DC are both stolen, the CB authentication methods prevent a thief or an attacker from issuing a PAY command.

The CPS DC also works for those buyers with only a cell phone. The CPS DC issued to a cell phone user does not have a NFC tag in order to avoid the possibility of duplicate reads, where a credit card reader reads both the magnetic strip and NFC tag. Upon swiping the CPS DC, the user of the cell phone receives a cellphone call from the CPC verbally stating the purchase parameters, upon which the cell phone user may make a numerical entry on the cell phone keypad to enter a “PAY” command. In one embodiment, the numerical entry is a secret private knowledge item that is selected by the user. The only data passed in the call is the dollar amount and the merchant's ID; neither of which is sensitive. Addresses used in the communications help establish the party on each end. The CPC could issue a voice print analysis challenge, over a connection on the cellphone, to minimize the possibility of theft and/or hacking.

Cellphones are being outfitted with attached credit card readers by sellers at flea markets, for example. The assumption is that cell phone service is available. In this case, a CPS client could provide the seller with the CPS DC. This would result in a message to the CB seeking a “PAY” command and displaying the dollar amount because the CPS DC is addressed to the CPS Bank. This mode of operating is explained to the seller, and the PAY button is selected. Up until the PAY button is selected, there is no authorization message sent to the seller. After sending the pay command, the authorization message arrives on the seller's cell phone, provided by way of the usual channels. No authorization message arrives until the client buyer selects PAY. Sending the pay command is over any wireless service available, data service, or dial-up if necessary.

In one embodiment, the seller may utilize a Matrix placard as a means of using CPS to service their payment transactions. The only funds removed from the total received by the seller, in this case, is a small CPS processing charge. If the number of CPS customers increases for this seller, the per transaction cost is reduced as more transactions are present in each batch payment.

One distinguishing CPS function is that the “PAY” command originates from the CB only when sufficient funds exist and the owner of the client buyer selects “PAY.”

Another embodiment relates to vending, and may utilize independent CPS two way communications using a transceiver interface module for use with vending machines. In one embodiment, the CPS Transceiver Interface Module-vending (CTIM-V) is programmed with all relevant invariant merchant transaction data, and enables encrypted communication between a CB and an automated machine that does not have a secure access to internal machine data. The vending machine also requires a machine data interface and processing function, on the machine side, that is part of the CTIM-V processor function. Three small, inexpensive, transceivers are used to uniquely identify the one CB from a large population, establish secure communications and provide a promise to pay if the good or service is provided. The CTIM-V transceivers can be NFC, Bluetooth and WiFi. This implementation supports an item vending machine, a venue access terminal, an indeterminant amount purchase, and similar vending. Each machine will have a CTIM-V that includes protocols that define the purchase modality. This can be referred to as the “hitch-hiker” mode because transaction data is carried by a smartphone until it can communicate. Operation of this mode does not require commercial communications in order to obtain the good or service because the CTIM-V supports two way independent client buyer communications. The CTIM-V retains a record of recent purchases. Every time a client buyer makes a purchase, it retains a copy of the transaction data record, and the previous three records for later forwarding to the CPC to insure the merchant is paid.

Another embodiment starts a direct connection to the merchant's internal processing, using a CPS Terminal Application (CTA). The CTA is used with a CTIM configured to work with the CTA installed in merchant terminals. Merchant terminal computers, like all computers, upload, download, update or remove software and establish digital interfaces. Each existing terminal application has a unique Intranet address reachable from the stores secure Intranet; the CTA also has a reachable address. The CTA is crafted by CPS and downloaded as an additional application operating on the terminal by the merchant. It is only active during a CPS transaction. By virtue of access to the terminal bus, it can obtain or insert data to enable obtaining the dollar amount of a transaction, and inserting an authorization. Because no credit card is being used for the transaction, there is no credit card provided authorization.

One embodiment of the CTA uses the point of sale application programming interface to install an application that facilitates access to the print file, with the CPU in the wait state, which presently contains the total dollar amount, invoice amount and other such data, and sends it to the CTIM where this data is extracted and sent to the CB. The CTA immediately releases back to the main program as it awaits the authorization as forwarded by CTIM. When the bus is not busy, the CTA briefly interrupts to download the same authorization from the CTIM for forwarding to the back office.

Another embodiment of the CTA is a native operation of the point of sale software which provides the current transaction data directly to the CTIM for forwarding to the CB and accepts the authorization for inserting into the print file and forwarding it to the back office. Provided with this print file input of the authorization, the existing application prints the receipt.

In this embodiment, the authorization is first sent to the merchant, and then the CB sends the PAY command to the CPC to direct the movement of the funds. Once the PAY button is selected, the CB will automatically send the PAY command.

Another embodiment is directed to Web purchasing and service provisioning using either mobile devices or fixed computers owned and operated by the owner of the CPS bank account. In this embodiment, CB's are enabled to make purchases from Internet based service providers and Web merchants. When using a mobile or a desk top computer, the CPS CPC is performing lower cost payment transactions and generating revenue to support CPS operations. When working within the web environment, it may be necessary to have a CPS Web Application (CWA) on the Web merchant's payment server, that places the promise to pay with the purveyor—which is initiated by the “PAY” command from the CB. The CWA operates on the same processor that has applications running credit card operations, as a parallel payment process. To the purveyor, CPS looks like another credit card, in that they get an authorization, except it is not presented by the credit card system, and they are paid by the CPS Bank.

CPS client sellers obtain loyalty directly to their brand from their loyalty offerings. According to embodiments, in the CPS, all benefits of loyalty offerings, such as coupons, accrue directly to the merchant rather than a third party.

FIG. 1B illustrates an example of a CPS according to one embodiment. As illustrated in FIG. 1B, a CB obtains transaction data from a CS 20, and, if all is in order, issues an authorization 21. Then, the CB sends a “PAY” message to CPS processing center 22, which directs the CPS bank to send funds 23 to the merchant's bank. The merchant's bank provides an accounting of the funds received from the CPS bank 24.

In one embodiment, a payment method using the CPS payment system (i.e., having a CTIM and a CTA) may include, for example, the following:

1. Buyer presents products to a cashier and obtains a total amount due for the products ($32.00);

2. Buyer selects the CPS application button on their smartphone.

3. Buyer presents their smartphone close to the CPS interface module.

4. Buyers display states:
Total available funds
Dollar amount due for this transaction and an adjacent “PAY” radio button
A New Balance display after the transaction is paid for

5. Buyer touches “PAY” button.

6. Merchants terminal prints out a paper receipt complete with authorization code and invoice number, showing the items purchased and dollar total.

7. Buyer departs with purchase.

According to an embodiment, as a result of selecting the “PAY” button, the CB automatically transmits the “PAY” command to the client buyer's CPS Bank. Buyer's CPS Bank then pays sellers bank.

Embodiments are able to authenticate that the owner of the CB is the person operating the device. Several techniques may be used to provide this authentication, as CBs then make purchases and establish secure communications to obtain transaction data from, and provide an authorization directly to, a client seller.

As part of the CPS payment method, embodiments also establish a secure two-way independent wireless communications interface with the checkout terminal. There are two parts to the seller's payment transaction data: invariant data and salient current sale data. Invariant data is preprogrammed into the secure communication interface. Current sale data is only available in the terminal processor that is computing the total dollar amount and assigning an invoice number, so a software application that communicates current sale data to the secure wireless communication interface may be needed. All this information is transferred to the CB so an authorization message can be sent to the application in the processor for insertion into the existing terminal application. The client buyer automatically sends all the payment transaction data to a CPS processing center. As mentioned above, based on a client buyer selecting “PAY”, the smartphone transmits a “PAY” command, and all the payment transaction data, to the CPC which goes to the CPS bank. CPS bank then pays merchants bank.

By selecting “PAY,” two key attributes are provided: delivering an authenticated authorization directly to the seller's decision process that satisfies their requirements to accept the promise of payment and then paying the merchant as a result of a buyers conscious decision to pay by executing a “PAY Command.” Two corollaries of this model are that the buyer is certain the funds already exist, before authorizing, and the only way for funds to leave a buyer's account is by the their active “PAY” command.

Thus, embodiments are able to: authenticate that the computer is operated by the owner, communicate securely between the computer and the seller, uniquely identify the computer (and thus the buyer) that is making the purchase, obtain the merchants transaction data, establish that sufficient cash is available to make the purchase, and deliver an authorization directly to the seller and insure payment.

As discussed above, a CPS Transceiver Interface Module for vending, (CTIM-V) may be used as one means of obtaining transaction data and provide an authorization directly to the processors used to control unattended dispensing, such as gas pumps, and item vending machines.

The CPS Transceiver Interface Module, CTIM may be used in merchant stores as an interface between client buyers and the merchants in-house secure processors for the purpose of obtaining transaction data and providing an authorization directly from the CB to the merchant. The CTIM, as a radio frequency and security interface between the client buyer and the merchants secure electronic system, when used in conjunction with a CPS Terminal Application (CTA), results in a client buyer that behaves as a trusted application, on the merchants Intranet. In all of these situations, authorizations are provided near instantaneously because they are provided directly from the client buyer, without the need for the clearance of others. An authorization directly from a smartphone to the merchants terminal processor bypasses the involvement of authorization requests by a merchants bank, an assessment by a third party automated clearing house, an assessment of sufficient funds by an issuing bank as well as obviating the need for an authorization message from the issuing bank to the acquiring bank, and from the acquiring bank to the merchants back office.

The merchant's side of a CTIM interface physically connects to the point of sale terminal via RS232, USB, Cat 5 or other interface, depending upon the vender of the equipment. In the case of a vending operation, it interfaces with that systems controls, and senses various functions, like “vend,” “did vend,” “cancel,” etc. In the case of a DAX VDI, or similar, equipped vending machine, the data is a serial feed of status data to the CTIM.

A CTA is needed to obtain data from, and supply data to, the merchant's terminal. In one embodiment, the CTA is a program downloaded into the merchant's checkout terminal under the control of the merchant. It observes the checkout terminal processor bus and either extracts transaction data or injects authorization data. According to an embodiment, the CTA is configured to obtain the merchants transaction data and send it, via the CTIM, to the CB. The CTA also may be configured to receive a CB authorization, sent via a CTIM or WiFi interface module, in the case of merchant using WiFi to support purchase and payment transactions. Once the authorization code is provided to the processor, it is sent to the terminal printer. The CTA also supports the existing bar code scanner by recognizing a code presented by a smartphone display as being a CPS address, or other recognizable code. Scanning the barcode can have two purposes. The first is to uniquely identify this specific CB being used for this purchase within the CTA so as to associate it with the dollar amount and other current transactional data extracted from the bus in the merchants terminal processor. The second is to send it from the CTA to the CTIM as the CB's Bluetooth address so as to pair with the CB and establish a secure independent communication link between the CB and the CTIM.

For in-store situations, the CPS may use a CPS Data Card, or NFC means of collecting the merchants transaction data (TD) by using the merchant owned card reader. Upon swiping this card, the CPS Bank receives the message that contains both the CB and merchant's transaction data. The CPC sends a message to the CB seeking a “PAY” command. If obtained, the CPS Bank then sends an authorization directly to the merchant's bank. The authorization arrives at the terminal, and the receipt is printed with the authorization code so the patron may depart.

The CPS can support both mobile, over wireless, and desktop/fixed computers over wireless or wireline, to purchase from Web merchants and service providers. The CPS may also provide services either free or for a fee, as a means of collecting revenue in a manner that integrates the management of various business building services, provided by third parties, or by CPS, into the payment of transactions because business building usually results in modifications to the payments associated with a transaction.

In general, there are numerous different types of access to sellers systems, all of which are as front ends of a CB and cloud based processing system that is integrally connected to a CPS bank or, initially, a CPS servicing bank. Unlike other banks, the CPS bank accepts funds from any legitimate source, such as direct deposit paychecks, funds from a government, or funds from a client buyers existing bank. However, there is only one way to move funds out of the bank: under direct control of the authenticated CB.

In one embodiment, the CPS system may include the CPS Bank and CPS processing center. Synergy occurs when all of the needed CPS processing is contained in one processing center that is intimately integrated with the CPS Bank. From a legal perspective, retaining the essence of a Bank is essential. There are numerous processing needs, such as accounting to merchants needed to reconcile their books as a result of making batch payments to their banks, keeping track of security aspects, and managing various service offerings, etc. Aside from business building aspects requiring processing, and providing the needed security functions, a function of the CPS processing center is to direct the actions of the CPS Bank. For this reason, the CPS bank, or CPS servicing bank, is functionally integrated into one CPS entity, that is, the processing center is the accounting function that maintains the status off all the bank accounts, and the processing center accumulates all the CB transactions for each merchant in order to make a batch payment to each merchants bank, so the processing center directs the bank to make a payment. The concept of a “bank” checking to see if the patron has the funds is also a part of the CPS processing center's function. While, the system is designed so that a CB cannot download accountability for more cash than is in the bank account, it is the responsibility of the bank to again determine that sufficient funds exist in the account, as a fiduciary responsibility, and as a test to detect fraud. The CPS bank receives traffic routed to it using IIN addressing, which it forwards to the processing center. The bank also sends authorizations that are proforma transmissions to facilitate proper functioning of existing merchant bank, back office and terminal communications on behalf of CPS. When the bank sends funds, as batch payments, under the direction of the processing center, to another bank, the processing center sends an accounting of merchant invoice numbers and dollar amounts to the merchants back office accounting function. There is no personal information used in the execution of a purchase or payment transaction, and none is delivered to the merchant's bank. The only connection between CB and the details of the account holder's personal information is retained in a secure CPS enclave.

Melding a Bank operation with a security certification process provides the basis for a more efficient operation. CPS performs this function when vetting persons for the purpose of providing a CPS issued certificate to enable them to establish secure communications with the CPS. As the product of this vetting process, the same information is obtained as required by regulation to know your customer as a CPS Bank account holder. This is more efficient than a separate certificate issuing organization and a separate bank each performing essentially the same function separately.

The CPS bank can initially be a CPS merchants servicing bank. Although funds may be placed in these bank accounts from any legitimate source, the only way out of an account is by control of its registered and authenticated client buyer. Client buyers may transfer funds to other CPS members within the CPS Bank, that are on a list maintained by CPC, as set up by the client buyer, i.e., family members and friends. When the dollar amount to spend exceeds a specified high dollar value, a challenge/response test will be invoked.

Criteria for being a CPS client are slightly different for client buyers and client sellers. Client buyers become members of the CPS by downloading a CPS application to one or more of their preferred client buyers, i.e., a smartphone, tablet, notebook or desktop. They may have a CPS application installed on more than one computer, such as a smartphone and a desktop or laptop. Potential client buyers are vetted relative to their likelihood of creating problems with regard to probing the system or otherwise attempting to compromise the CPS network or nodes on that network. Client buyers must open a CPS bank account where exclusive control of funds leaving that account resides with the registered client buyer. Their account is opened with an initial deposit from their personal bank account by using the free bill paying feature of their present bank to deposit their funds into the CPS bank. The owner of a client buyer may download, as an extension of the CPS accounting function, a specified amount of the cash in the owners CPS bank account. The specified amount downloaded is the amount the client buyer is allowed to spend.

Having a CB provides an extremely powerful capability, i.e., to “PAY” with the touch of a single button, which has a concomitant need for a powerful ability to prevent unauthorized use by others. CBs, in addition to controlling, have a responsibility to validate that their owners are the persons operating them before they are allowed to control. Thus, there will be a need to display some private knowledge, and some biometric knowledge for a dollar amount over an owner preprogrammed threshold. Their ability to control flows from their authenticating the CB user. Knowing anything that someone else is able to determine is not a means of authentication, such as your zip code or home phone number. Possession of a CB is outside the domain of authentication. The possessor of a credit card, or a credit card number, is no indication that it is being used by the owner. The way to keep a secret is to not give it a name, or descriptors, such as not having a name linked to a number linked to a function that has a name. Not having physical devices that contain the linking of several names, i.e., of the name owner and the processing organization, and numbers, together with that same device that can be fraudulently exploited. These same rules apply to computational, communicating devices; fixed and mobile.

In certain embodiments, the methods of authenticating the user of a CB are based upon private knowledge and biometrics. Private knowledge is based upon prior personal knowledge gained from experience that no others were exposed to because it is already remembered, and has been for a long time. Less suitable is private knowledge created at the time of establishing a “private knowledge database”, such as assigning a personal identification number, or PIN.

Embodiments are able to make authentication tests as un-intrusive as possible. These tests can be part of a sequence of almost subliminal nature. As an example, the user activates the CPS application by selecting the “CPS” icon on the main menu of their device. This brings up a 3 by 4 array of yellow dots. Touching the correct dot opens the application. A random question is asked with one of several one word answers with an associated button. Depending upon preprogramming a high dollar amount, in addition to activating the “PAY’ button, the user must speak one word into the smartphone; the owner pre loads the word to be spoken. CB spectral analysis software matches that spoken word with the stored file. Failure of any one of these elemental tests will result in a challenge/response that is managed by the CPC, over the Internet, i.e., a complete sentence must be spoken, or, on request, an image of the user taken, which is processed by the CPC. The result can be to enable the user to select the “PAY” button, which has another private knowledge and biometric test; which of several squares to present the finger, which finger to touch it with, and then a local analysis of the fingerprint before presenting a note of “purchase complete.” The aforementioned tests and sequences will be varied, and other tests not mentioned herein may be used according to certain implementations. When out of communication range, there is a dollar limit on the amount of funds that can be “spent” for each purchase by the CB, depending upon a threshold preprogrammed by the owner.

The “PAY” command, as used in the CPS method, may be a button present on a client buyer with the associated dollar amount to pay. According to an embodiment, the CPS system is configured to display the “PAY” button when all of the conditions needed to make a payment transaction are met. For example, all of the seller's transaction data must be available on the client buyer, by one of the several methods described herein, and there must be a sufficient balance of funds on the CB. Finally, in the process of selecting the PAY button, if a private knowledge rule is violated, the PAY button is replaced with a challenge message. The owner of the client buyer must know which type of test will be invoked, and respond accordingly. If the test is a voice print challenge, the owner must know what word to speak, and speak it, so as to successfully meet the challenge. The client buyer then returns to the previous screen for another opportunity to execute a payment transaction using private knowledge. Failing a second time turns off the CPS application until it can be reestablished by CPS personnel. For those mobile devices, or desktops with plug-in fingerprint readers, the fingerprint becomes the first bio-metric authentication test because it is a natural part of touching a button on the device display capable of reading a fingerprint. Failing a fingerprint matching, the CB goes into the challenge/response mode.

As a result of this system, a CB may make numerous purchases without communicating with the CPC. It is not necessary to justify the two accounts upon every transaction. It is possible for a client buyer to continue making numerous small dollar purchases until the amount of funds remaining on the CB are depleted. At that point, when additional funds are sought, over an Internet access, all the transaction data is downloaded before new funds are transferred to the client buyer. Also, if the CB enters an area of commercial communication packet access while containing any transaction data, it will automatically connect with the CPC and download all the saved transaction data. Even though this communication may be subliminal, it is operatively sending the PAY command, with all the transaction data for each purchase.

Entities become CPS clients when they sign up to open a CPS client bank account, and are approved by the CPS vetting. Any source of funds entering a client's CPS bank account must the approved by the client. For example, a monthly salary payment may be direct deposited, or U.S. government checks may be deposited; thus, there is a client employer and a client government, etc. To minimize fraud, or money laundering, previously unspecified accounts may not provide funds to a client's CPS bank account, and if attempted, a message is displayed on the client buyer announcing the information of the would-be depositor, in the event the client elects to add them to the list of acceptable depositors.

Sellers become client sellers when they sign up for, and employ, any one of the numerous methods available for client buyers to access their business transaction data for the purpose of making a purchase using the CPS system. Sellers must also set up a client seller's bank account. While processing purchases and sending funds to the merchant's bank does not require a CPS bank account, other functions of the CPS system may result in CPS funds being deposited in, or extracted from a client seller's account, under their control. Underlying the solution to the CPS is a robust security platform upon which to build an independent mode of operating a payment transaction system. In one embodiment, an interface module provides a secure two way communication port between the client buyer and merchant, and a software application running on the merchant's terminal interfaces with the merchant's processing system, as a trusted agent. The purpose of this agent is to obtain the merchant's current transaction data, such as dollar amount, invoice number, and any other data, such as the name of the waiter or cashier, etc., and also to accept authorizations directly from a client buyer via the CTIM independent two-way communication interface module working in conjunction with a CPS terminal application operating in the merchants terminal. Merchants have invariant transaction data, such as store number, etc., that is programmed into the CTIM, as a constant part of every transaction.

A major aspect of a security platform is to authenticate that the user of the client buyer is the rightful owner. Personal identification numbers, although popular, are weak security. While CPS clients may elect to use a PIN code, it will not be used as the only authentication factor. For smartphones, there are numerous methods that may operate inherently at the time of a purchase. If the dollar amount is high or if there is a high fraud score, an automated overt system of challenge/response tests will be initiated.

Smartphone displays are actually transceivers, able to illuminate pixels, and also able to read the presence of a physical contact on the screen by use of capacitive sensors in sufficient detail to read a fingerprint. Selecting a button on a smartphone, by touch, is more than invoking a function, such as “PAY,” it is also performing a biometric test of a fingerprint. The owner decides which finger will be used to activate the correct “PAY” button. The operator interface presents a matrix of two by three squares, one of which is known only to the owner as the active square for fingerprinting or otherwise. Touching the correct button provides two tests; the owners private knowledge and a fingerprint that has a high probability of confirming their identity from a large population. A users fingerprint identification pattern matching starts with a version stored when the customer sets up the security profile for their CPS mobile device by entering their fingerprint pattern as a reference. In use, touching a button compares the current version with the stored version each time a button is touched to control a function. Matching is a fast correlation process. Touching the wrong square initiates a CB challenge to which the response such as to speak a certain word, which is analyzed by the CB application. For a higher level of potential fraud protection, a complete spoken sentence (known only to the owner) or a photo of the person, that was originally stored at the CPS processing center (CPC) as a reference, is sent for analysis, with the results returned to the CB. If the match fails, the CB application is turned off. Storing challenge/response references in the cloud is more secure than storing it on the mobile or desktop. The fingerprint test and a spoken word match would be processed on the CB. Smartphones can take pictures of the user which may be digitally compared at the CPC. Most of these images can be automatically processed.

The intent of the authentication scheme is to make it as transparent as possible to the client buyer owner, so they are not tasked to recall a pin number, although, if an owner prefers a pin number, or other memory peg, it could be provisioned to be part of a silent test, or the challenge/response program. Challenges occur when there are other reasons as determined by the CPS. A client's hardware/software stored MAC address, CPS account number, serial number, etc., are used in each transaction as part of transparent security checks. One transaction, forwarded to the CPC by the CB, where these do not match causes the CPC to turn off the CB application. In addition to the CPC using these reference numbers, the CB retains, in a secure memory space, these numbers, and actively checks these numbers, as extracted from the usual smartphone software, to insure they match, as the first line of defense against creative software/hardware manipulation.

There are numerous methods according to certain embodiments to guarantee the user of a desktop client buyer is the owner. The first step is to use that desktop computer when setting up the account; the CPC downloads the CPS application onto that computer, gathers all the parameters, such as MAC number, etc. of that computer, and registers that application to that computer and to that person who is the owner and selects private knowledge items of their preference.

Most computers have built in microphones, or microphone jacks, useable for recording a phrase spoken by the rightful owner, upon vetting as a client, and used later as a reference for a biometric challenge/response test. Like smartphones, for those desktops with a camera, a self portrait is captured and stored as a reference. Desktop computers could be required to use an inexpensive USB fingerprint reader, the serial numbers of which can also be ingrained into the desktop computer For those desktop computer users that also own CPS registered smartphones, with fingerprint and other authentication features, there is the option to require connecting the smartphone to the desktop and use both the desktop and additional authentication capabilities of the smartphone, such as its fingerprint reader, to enter the authenticated PAY command.

In addition to insuring a person's authentication relative to the computers in use, there are also numerous Internet security issues related to insuring a validated sender and a validated receiver. Encrypting the traffic, such as using a public key infrastructure, is a necessary, but is not a sufficient condition to insure Internet communication security.

Unfettered Internet communications security is essential between CPS nodes in the field and distributed servers supporting the CPC. Various methods of securing Internet traffic depend upon certificates that are based on a validation authority. According to certain embodiments, CPS will operate as its own certificate authority, having authenticated knowledge of those on each end of the communication.

There must also be an option for the CPS Web server application operating on the merchant's transaction processor to securely query the CPC. If a fraud score question is raised in connection with that desktop, the CPS Web application on the merchant's processing server has in place means to communicate securely with the CPC, so a challenge/response test could be conducted using the spoken sentence as a voice print check against the stored reference at the CPC. In this case, as a subroutine, the CPS Web server application sends a message the CPC and relays the digital version of the spoken sentence where a match is performed and the CPC quickly responds to the CPS application on the merchants server if the speaker is authenticated, to terminate the present session, or to turn off that desktop computer application. All relative parameters are stored for future reference, as part of forensic analysis. Turned off computers will have parameters stored as a basis for being turned off, against which the owner of the client buyer can make a case to reinstate the application.

Communications can be between clients that wish to communicate with each other securely, either for the purpose of secure messaging, or for moving cash from one party to another—regardless of their physical location, such as between family members. This too, is a function of provisioning to enable funds transfers only between those clients listed. Secure text communications can be between any two clients sharing addresses. The text may be limited in size and the content of the message may be drafted within a secure space in the CB client buyer application.

Independent two way communications between client buyers and client sellers are needed to conduct transactions in a variety of different seller environments. Smartphones are equipped with programmable NFC tags, Bluetooth and WiFi. NFC, Bluetooth and WiFi readers/transceivers are small, inexpensive and needed to establish two way independent communications with a smartphone. These will be used to uniquely identify one CB from a large population of CB's in the local area, and for making purchases over interfaces, including making purchases over WiFi interfaces used in local stores that offer free WiFi.

Smartphone image capture and processing and sensing/processing capabilities are also a rapid means of communication; as will be described for unique identification of a buying CB, or identifying a rural seller, and others, a means of gathering the merchant's invariant transaction data using matrix barcodes on a placard.

The CPS Transceiver Interface Module, (CTIM) is a small inexpensive module, connected to a seller's machine or checkout terminal, with associated processor and memory, placed within convenient reach of a CB user. The CB is positioned in front of the module. The CTIM provides the option of using multi-colored light and/or sounds as status indicators. It retains a record of transactions. The CTIM also communicates with a CPS terminal application (CTA) that is installed on the merchant's terminal to exchange data with that terminal, such as obtaining the current transaction data and delivering an authorization to the merchant.

The CPS Transceiver Interface Module can perform several functions, including: electronically uniquely identify one client buyer from a large population, establishing independent secure two way wireless communication between a the CB and the CTIM or CTIM-V, establishing independent secure two way communication between the CTIM and the merchant's Intranet or CTA, establishing independent secure two way communication between the CTIM-V and the merchant's vending machine, establishing a secure two way connection between the CTIM and the clients processor interface, establishing the connecting interface between the secure CB two way wireless communications and with the CPS application running on the sellers terminal processor, managing encryption/decryption of the data exchange between the CTIM communication with the CB and the encryption/decryption of the data exchange between the CTIM and the CPS Terminal Application running on the merchants checkout terminal processor, establishing communication with a host merchandising and data logging system, such as reading out previous transaction data, from the CTIM-V, for accounting purposes, or acquiring machine status data, storing all payment transaction data for a defined period, providing transaction data to a CB from the merchants terminal, providing an authorization from a CB to the merchants terminal, providing transaction data of the present and previous three transactions to the CB, and providing randomized data for non-secure messaging back and forth between the CB and the merchant via the CTIM.

The CTIM operates three different protocol and radio frequency communication types: Near Field Communication, Bluetooth and WiFi. These are radio frequency front ends for digital signal processing involved in managing communications, managing security, passing traffic to and from a CB, for an in-store situation, managing traffic to an from a CTA that runs in a CS's terminal, for the purpose of obtaining the sellers transaction data and providing authorizations from the CB to the CS.

The CTIM provides secure communications between a client seller and a client buyer. The CTIM comes in two configurations, depending upon the merchant's infrastructure: dual encryption engines or a single encryption engine and a machine interface processor. Each has a secure wireless interface and control processor with memory. In addition to managing communications and interfaces on the client buyers side, the interface and control processor memory stores current and previous transaction data records long enough to enable a later reconciliation of events if necessary. There is a way to download several months of previously stored transaction data from the CTIM. The dual encryption version of the CTIM processor works with a CTA to obtain transaction data and provide authorizations. The CTIM-V version has a processor designed to interface with vending environments of various types. The CTIM-V uses a CB in a “hitch-hiker” mode because it enables the authorization and purchase from the machine without the need for commercial communications. In the hitch-hiker mode, data relative to the last four transactions and any machine status desired by the vending owner is forwarded when the CB enters an area with access to packet communication. The CPC sends status data to the machine owner, checks that the previous transactions forwarded were processed per the transaction data provided, and, using the most recent transaction, pays the seller.

The concept of payment is that when large numbers of CB's are in service, all of their purchases are allocated to the proper seller. Each seller accumulates a substantial number of accounts to be paid which are forwarded periodically in one batch payment with an accounting of all the invoice numbers, authentication codes and dollar amounts in a format, similar to electronic data interchange that interfaces with their accounting system for the purpose of automatic account reconciliation, and detecting errors or fraud. No buyer personal information is used in the CPS system either for conducting the authorization, payment transactions or accounting to the seller

CTIM antenna patterns and communication ranges also play a role. The antenna pattern for NFC is the standard near field hemisphere. The CTIM NFC reader sends and receives in a small volume, nominally a hemisphere of about 10 inch radius, within which the CB is presented for reading its NFC tag or NFC transceiver. NFC devices outside this range are not able to detect the communication, i.e., it is low probability of intercept. This placement identifies the specific CB that is making the purchase and, by passing traffic, usually the Bluetooth address of the CB, which starts the sequence to a more highly encrypted state of communications using WiFi.

Bluetooth can be operated in a low power mode to reduce the operating range to about ten feet in the main beam. The antenna pattern for Bluetooth is somewhat narrow, with suppressed sidelobes, so that it can be aimed at the general location where a CB would be present to make a purchase. This serves two purposes: it reduces the area that covers the CB such that much of the CTIM transmitted energy not used by the CB is absorbed by the user, and fewer CB's in the sidelobe sectors will detect the Bluetooth CTIM transmissions. For the case where NFC is not available, Bluetooth will be an alternative mode used to uniquely identify the purchasing CB. WiFi uses a standard chip and antenna.

The CTIM-V version interfaces with the vending machine's signaling, sensing and electronics. It is designed to download status, such as DEX VDI machine status data, This is forwarded, randomized, via the CTIM-V interface to the CB at the time of a purchase. The CB purchasing sequence starts with selecting a product that has a listed price. The price is transmitted, via the CTIM-V, to the CB. The seller's transaction data is also sent to the CB. The CB selects the “PAY” button causing an authorization to be sent to the seller. On previous agreement with the vending machine seller, the machine will vend the selection based on having the authorization, which is sent by the CB, to the CTIM-V processor. After receiving the encrypted authorization code provided by the CB, the CTIM-V, via the machine data processor and interfaces, directs the machine to dispense the product. The CTIM-V is a trusted agent that stores transaction data, and, by forwarding to the CB insures that the seller will be paid. The CTIM-V can retain all the transaction data. The CTIM-V also accepts data considered important by the seller to cost effectively maintain their machine, for forwarding to their machine servicing function, and also sends, as encrypted data, the current transaction data, and three previous sets of transaction data, to the CB. The CB carries this data, and all the DEX VDI data until it reaches a packet communication service whereupon it downloads all that data to the CPC. The CPS sends status data to the machine owner, and pays the seller.

Often, prospective in-store purchasers standing in line are being totaled by a traveling handset reading UPC codes. A means to associate that CB with that list collected while in line is needed. Toward this end, the CPS application on the CB can be activated to display a dynamically assigned random non-standard barcode, just for this situation, that can be scanned by the traveling handset reader. Then, for CPS clients, when they arrive at the CTIM, and establish secure communication, this barcode data is sent, via the CTIM to the CTA. The CTA, monitors traffic on the bus, recognizes the random barcode, and associates the dollar total and other transaction data, with that barcode and proceeds with the authorization process as provided by the CB.

There will be a period when not all CB's have NFC, so other methods are enlisted to separate one CB from a large population, depending upon the circumstance. If available, a bar code scanner capture of a CB generated pattern could be used to connect a specific CB with a specific CS. The displayed barcode could be the address to the CB. The barcode data is extracted by the CTA and forwarded to the CTIM. Although the number being displayed has been randomized; it is de-randomized within the CTIM and inserted into the Bluetooth address, enabling a secure Bluetooth link to be established. Once a secure Bluetooth link is established between the CB and the CTIM, additional information is transferred which enables the WiFi link to come up encrypted, and the process proceeds the same as the mature operating mode.

Rural CSs with available commercial communications can use a Matrix barcode placard, which, when scanned by a CB to collect the data which is used to connect a CS to a CB; a necessary condition to start a payment transaction. It provides the sellers CPS account number, email address, Bluetooth address and telephone number as randomized numbers. The rural mode works where there is either a seller with Bluetooth direct connect, i.e., without the need for other communications, or there is free WiFi or other commercial wireless communications available. With the Bluetooth addresses known on each end, an agreed passkey is used to start a secure Bluetooth session if the seller has a smartphone. For a seller with a basic cellphone, once the dollar amount is entered by the customer into the CB, and sent to the CPC, a CPC generated computer spoken dollar amount and authorization code is sent as a voicemail to the seller's cellphone and an email is sent to the address on the Matrix placard.

The Matrix placard is a low cost of entry method of collecting payments electronically for small scale activities such a as selling cookies, collecting money during a holiday season, or selling food from a truck. The user of the CB enters the dollar amount manually. If the seller does not use a smartphone or cellphone, the transaction is securely registered on the CB, and the CB displays the seller's name, dollar amount and an authorization number, for viewing by the seller, as a confirmation that the CPS has acknowledge the transaction. Sellers can receive an accounting with each batch payment.

When the smartphone does not have NFC, Bluetooth is be used to associate a CB with a CS, albeit with some additional considerations. Even with a reduced range and a more narrow beam pattern, Bluetooth requires additional differentiators because of the possibility of multiple CB responders, even though only the purchasing CB is sought. When more than one CB responds, other steps are necessary. The terminal number can be used to further reduce the possibility of which is the sought CB. Instead of the user of a CB manually inserting the terminal number, the CTIM, otherwise ready to proceed with a purchase, broadcasts a WiFi message that states the terminal number. In the absence of nefarious actors, the sought buyer observes their terminal number, as prominently displayed at the seller's checkout terminal, and selects the CB button that displays that terminal number. Most often, only one CB will respond using WiFi, and in so doing, the respondent provides their WiFi address. In that case, the transaction proceeds. It is understood that even with this technique, it is possible two or more CB's select the terminal number button. In that case, the message from the CTIM is to enter the dollar amount, i.e., manually. In this situation, the dollar amount, usually displayed in small font on the credit card reader, and thus not viewable by others, is entered and sent to the CTIM to establish the purchasing CB.

There can be indicators provided on the CB display to verify its presence in the NFC or Bluetooth beam, as well as to indicate a secure connection and successful completion of the transaction. Also, a multicolored light or sound indicator of status is available on the CTIM to indicate in-process status, or completion of the purchase.

The CTIM WiFi transceiver, by use of the encryption engine for the wireless link, and the encryption engine used in connection with the encrypt/decrypt engine in the CTA, establishes a secure link between the CB and the CTA. WiFi normally passes transaction data and authorizations. In the event of a WiFi device failure in a CTIM or CB, the CTIM switches to passing the encrypted traffic over the previously secured Bluetooth link. For system maintenance, a failed WiFi node is reported to the CPC by the CTIM, i.e., it travels over a subsequent transaction download to another CB.

Normally the CTIM Bluetooth chip is constrained, by the CTIM processor, from operating in the discovery mode until released. In the case of a NFC reading, when the CB Bluetooth address is passed over the NFC link and inserted into the CTIM Bluetooth chip, its constraint is released, and it immediately pairs with the CB to further the security setup dialog. The CB WiFi address and a security code is passed securely by Bluetooth, and the CTIM comes up in an encrypted WiFi link with the CB As an alternative, the WiFi address and security code could be passed by the NFC link, directly resulting in a secure WiFi link, and the process proceeds with making a payment transaction.

The presence of a detectable bi-directional NFC capability is easily determined. In the event a smartphone has a bi-directional NFC link, it is practical to complete the transaction using only NFC. In this mode, the CB can be removed from the NFC field, so the operator interface can be viewed and the “PAY” button activated, and then returned to the field to complete the purchase.

A smartphone without NFC may be programmed to transmit a precise length WiFi message, in response to a CTIM query when a payment transaction is ready, containing the number of the terminal and a randomized version of the Bluetooth address, which becomes a part of the startup for securing a communication link. Initially, the CTIM is not aware of the CB's capabilities. Rather than require a CB user to enter a terminal number, the CTIM broadcasts, over WiFi, the terminal number, as an indication it is ready to receive payment. If the smartphone is NFC capable, and presented for reading, this changes the dynamic back to an NFC process. But, in this case, when the total is ready, as determined by the CTA, the CTA sends this total to the CTIM which broadcasts a message in the clear, containing the terminal number, which is displayed on the CB. When responding, by touching the button that confirms the terminal number, the CB provides its WiFi address (not as a message, it is in the protocol) when responding with the terminal number of the CB and the randomized version of the Bluetooth address. Now with the CB's Bluetooth address known to the CTIM, Bluetooth can come up encrypted. The Bluetooth sends a security code from the CB to the CTIM, and the WiFi link comes up at a higher level of security. Using the NFC access simplifies establishing a secure WiFi link.

In one embodiment, the vending machine, or checkout terminal number may be inserted into the CTIM manually by the installer. Invariant merchant data is pre-programmed into the CTIM.

The vending machine, and other stand-alone applications, as well as rural sellers can use a hitch hiker mode; which is a representation that data from these machines travels in a client buyer until it comes into contact with a communication access, whereupon it is automatically forwarded to the CPC. Meanwhile, based upon the authorization provided, the good or service has been obtained.

Rural sellers could opt for a CTIM which would enable them to function in a mode similar to the vending machine mode, i.e., without the need for a CTA. For this case, the user may be required to enter the dollar amount.

An in-store operation normally supported by a remote back office may lose continuity, or a server may go down, usually resulting in the store having to suspend operation, or take only cash. By using the CPS, they can continue operating. As usual, the merchant's checkout system totals the bill and transaction data is obtained, acted upon and an authorization provided—all of which is retained on the CTIM; no differently than during normal operations. The merchant's terminal prints out the bill with the authorization code and invoice number so the customer is free to leave. A substantial number of these transactions can be stored on the CTIM. And, they are all forwarded to the CPC so the merchant is paid. If merchants eventually subscribe to the benefits of having CPS for a back up mode, it would not be difficult to incorporate the ability for the CTIM to also retain all the individual product UPC codes, obtained by the CTA, as well as the total of each transaction.

Some merchants may prefer to use their public WiFi to transport payment transactions. This may require a CPS Interface Module for WiFi access (CIM-W) and a CTA. To use the public internet in a seller's environment, a CIM-W can encrypt the wireless link between the CIM-W and the CB, as well as encrypt the secure link between the CTA, operating over the store Intranet, as a trusted agent in the terminal, communicating with the merchants Intranet interface side of the CIM-W.

To operate securely over the seller's public WiFi node, may require identification of the CB which could be accomplished by the CB displaying a bar code to the merchant's bar code scanner. This determines the terminal associated with a CB purchase. Scanning the CB provided bar code number results in this number being obtained from the terminal bus by the CTA and sent to the CIM-W together with the terminal number to track that transaction. When the CB is in the “public WiFi mode,” and communicates with the CIM-W the same bar code number is included in the communication, for associating that specific CB with that transaction. While this solution requires both the CIM-W module and an installed CTA, the per transaction costs are substantially less, as more of the intended CPS operations are used. Again, the user of the CB is witnessed touching the “PAY;” a waypoint to a more mature CPS.

Setting up a secure CIM-W solution associates the barcode with a specific CB WiFi address within the merchant's system. The CB displays the barcode, and immediately thereafter sends a randomized bar code message in the clear to the in-store WiFi. Now the CIM-W knows the CB's WiFi address, barcode session ID and terminal number of the CB/terminal processing the purchase.

As an alternative, the CB could use the CPS Data Card and make a purchase via that path, which is more expensive. If the CB is NFC equipped, it could present the CB to the merchants NFC reader, if one is available, and the transaction would proceed as a CPS DC mode—even though the CB initiated using its NFC, because it has essentially the same data as the CPS DC. The only difference is that each NFC tag has a distinguishing code that indicates if the source is from a CPS DC or a CB; which is needed so the system knows which process is next.

Without a barcode scanner, the CB and the CS can quickly establish a secure WiFi link using two encrypted paths that already exist. As the normal course of business a secure path already exists for both the CB and the CIM-W to securely communicate with the CPC. From a Cloud perspective, both could query the CPC to obtain a public key for a session, and then both could come up secure, and communicate over the stores WiFi link. Or, a CB could initiate a key, randomize it, then encrypt it and send it to the CPC; the CPC decrypts and re-encrypts for sending it randomized and encrypted to the CIM-W enabling both to come up secure after both the CB and CIM-W de-randomizes it. The CIM-W has two encrypt/decrypt engines, and works in conjunction with a CTA. One provides security for the wireless link between the CB and the CIM-W. The other provides security between the sellers CTA and the CIM-W. Traffic is passed from the secure wireless regime to the secure Intranet and CTA regime by means of decrypting the incoming CB traffic and presenting it, in the clear, to the other encrypt/decrypt engine for re-encryption, using the sellers Intranet keys. This provides a connection between the CB and the CTA in the seller's checkout terminal. Using this path, the seller's invariant and current transaction data is obtained by the CB and authorizations are sent to the CTA. As usual, provided the incoming authorization, the terminal proceeds to print out the receipt for release of the customer.

According to an embodiment, the CIM-W has an encryption/decryption/randomization engine for the wireless traffic between the CB and the CIM-W. Also, randomization is provided in the event a seller wants to send messages to a CB that are unrelated to secure communications. It is also used for non-secure traffic between the CB and the merchant. For example, customers sitting at a table could order more product from a mobile menu without leaving the table, or call for a waiter.

Incorporating tip payment service into the CPS has the problem of persons not otherwise known to the CPS. One way to deal with this issue is to invite all the servers in the establishment to join the CPS in order to have funds deposited into their accounts. Another way to support tips is to allocate the distribution of tips through their employer, and insure a mechanism is in place where the waiting staff has access to the data that presents what they are due. The latter is solved by enabling members of the waiting staff to view their tip amount. This is done by providing them account numbers that access the accounting records of only their portion, at that employer, that addresses their tip total over the period of a batch payment.

CPS addresses the payment of tips by patrons by including both CPC accounting, and tip data capture at the time of providing an authorization. Typically tips are extracted at the end of the workday as cash. While that does offer an immediate solution, there is the labor problem involved in determining the tips to be paid to each waiter. CPS enables automated tracking of tips for each member of the waiting staff.

CPS provides a tip menu, which is activated by the CTIM, where the invariant seller's data causes the tip menu to appear on the CB. The CB has a range of tips to select from in 5% increments on the display with the total dollar amount. Selecting tip % causes the dollar amount to increase accordingly. Thus, the CB user has the option of paying the total plus a tip, or paying just the total, and, possibly, paying the tip as cash.

When accounting for tips due to each waiter/waitress, the data collected by the CTA, in addition to the dollar amount, invoice, date and time, etc. is the name of each server is gathered as it is prepared for printing the receipt with all the other data. When presenting the “PAY” button, the server's name is presented on the CB display, so the CB can confirm with the printed hardcopy. Each time a CB enters a tip amount to a named server, that data is send along with the payment transaction. All the tips paid are captured and forwarded with the rest of the message sent to the CPC. The CPC breaks out the tips into accounts per the names presented by the seller.

Batch payment is made to the seller. After the sums are totaled, and accounting of the sale amount and the tip amount are totaled, the seller receives the total of both on the accounting provided to the seller. Thus, for the period of the batch payment, the subtotals are computed as part of the CPS service to small businesses.

The CPS Terminal Application (CTA) performs several functions in addition to the gathering of current transaction data for transmission to a CB, and receiving authorizations from the CB and inserting them into the process of the terminal.

The CTA supports encrypted communication with a CIM-W or a CTIM, as defined by associated protocols. The CTIM may be hardwired to the merchants terminal, thus, this connection must be encrypted. Similarly, the CTA is connected over the seller's Intranet, and thus, to be a trusted agent on that network, must encrypt/decrypt using the same methodology as the Intranet.

In some embodiments, the CTA also assists with using a barcode scanner to identify the purchasing CB. Data optically sent to a scanner is randomized, with a protocol header that identifies the data as from a scanner, is captured and sent to the CTIM, or CIM-W

Therefore, the terminal application (CTA) serves at least these functions: supports the uniqueness determination; gathers transaction data; interfaces with the merchant's side of the CTIM or CIM-W; is part of the pathway to provide a CB authorization to CS; and sends authorization messages from CB's to the back office.

Applications resident in a merchant's checkout terminal have addresses so they may be maintained over an Intranet access. The CTA, downloaded by the merchant, or vender of the merchant's terminal, also has an address on the merchants Intranet.

In addition to a CTIM, or a CIM-W, a CPS Terminal Application (CTA) is required to be the intermediary within the merchants terminal, i.e., to obtain transaction data from the merchant, for sending to the CB, and accept authorizations from the CB. The CTA also tends to sending a CPS authorization and CPS transaction details to the back office. The back office usually receives authorizations from the merchant's bank. The CTA, by sending the authorization to the back office, mimics the authorizations as would be delivered by the merchant's bank to the back office.

The CPS supports mobile and fixed computer Web purchasing and provides service offerings to build business for sellers. Service offerings are one of two broad categories; CPS and outside service providers, that all go through the CPS. This is done to retain control of disruptive activities that would certainly occur if content on the smartphone were open.

The underlying fabric of all aspects of Web merchandizing and service provision is that data flows occur over the public Internet. Client buyers nominally have wireless access; fixed computer access can be over cable, or wireless, over a local wireless Internet node. A Web merchants Internet interface, and payment transaction processing, in general, have the same look and feel, and CPC behavior, for either the desktop or the mobile devices. The variability in merchant and service models is almost without limit; as each may be tailored to the merchant's specific needs. The CPC creates applications to support most of their needs as generally applies to business building. Accounting is presented to merchants in one of several formats, and they may be the basis of automated account reconciliation.

One embodiment provides CPS business development features in which all types of promotional offerings that offer clients benefits of membership in a business discount model, or offering coupons for occasional use, are electronically managed by the CPS processing center. As an example, a customer may have 100 purchasing cards offering discounts for repeated business. All of these cards are replaced with 100 data accounts managed by CPS so that when they purchase at the business offering the discount, the discount is automatic because CPS has both the discount offering account number and the transaction data that identifies the offering business so the discount is calculated, and available on the CPS Web interface to the CBs bank account status showing the reduced payment amount paid and the amount associated with the PAY button at the time of the purchase.

CPS offers a low cost Web merchants' payment service for small volume outlets. For this mode, payment does not require an installed Web merchants' application. This mode requires that the Web merchant obtains a security certificate from the CPS, can use existing forms of security, such as https, and is willing to format their electronic billing in a block of data like the Electronic Data Interchange format.

Using this mode, the CB selects a product to purchase and requests a bill to be paid. Often sellers will ship the product before receiving the funds. Others require the funds before shipment. In the latter case, the Web merchant sends a bill to be paid in email to the CB, stating the price to pay, with all the merchant's transaction data, including the merchant ID, from which the servicing bank can be determined by the CPC. By a copy and paste operation of the Web merchant's transaction data, or “turning around the format back to the merchant,” by the CB selecting the “PAY” button for the items, the invoice number and amount, etc., the CB assigns an authorization number which is sent to the Web merchant. The authorization is a promise to pay. This same message is sent to the CPC, by the CB, fulfilling the “PAY” command. The Web merchant's bank receives payment from the CPS bank with the associated invoice number, and the merchant obtains an accounting of the dollar amount and invoice number after the bill has been paid, with an accounting of the transactions contained in the batch payment to the merchant's bank.

According to an embodiment, the CPC processor may have a database of the bank and account number of all merchant IDs; for known sellers, there is usually no need to send the merchants' bank account information because the CPC has a database of the bank account data for each merchant ID. An unknown merchant supplies the IIN. This improves security and simplifies matters if the merchant changes banks.

Volume web merchant processing uses an application that operates on the same merchants processor as credit card payments. The CPS is no different; the merchant processing requires a CPS application that operates to perform a CPS payment transaction. This application is referred to as the CPS Merchants' Application, (CMA). This would apply to purchasing such things as books or other products from a high volume site. Service providers have a CPS Service Providers Application, (CPA).

CPS may also have a web site so members may interface with their accounts, obtain free CPS services, or purchase a good or service from the CPS site. CPS also offers business building features, such as members converting rewards deposited into their account into chances to participate in the winnings of a small lottery pool. Separately, the CPS participates in a lottery where, if the lottery pays, it is equally divided among all CPS clients. This portal also provides for independent services providers to access a service provider's interface.

According to an embodiment, merchants may sign up for an “Ads that deliver” service. CB's can search a table of ads so users can search for what they want, such as a restaurant, events, and items to purchase as provided by independent merchant offerings. “Ads that deliver” enable correlation of a selected ad followed with a purchase at the merchant that posted the ad. Posting ads are free. The text, vetted by the CPS, is created by the merchants, nominally two or three lines of text, and entered into the search list. This model charges a fee only when the ad is selected and a paying patron visited that merchant. Merchants may offer short videos as either ads, with a fee for each viewing, or as entertainment for a fee. Numerous other service offerings are possible, such as purchasing instant short term insurance for just purchased motorized vehicle, etc.

Service offerings can be of two broad categories: CPS and outside service providers. In each case some services may be free and some may be fee based. Profits from operating CPS fee for service offerings are applied to underwriting the operation expenses of the CPS. Profits from outside providers, after paying a nominal fee for using the CPS platform, belong to those service providers. There are numerous promotional programs available to sellers based upon metrics established by the seller. These are easily presented as a long list of plans from which sellers can choose, as well as set their parameters.

The CPS Processing Center (CPC) provides a method to enable down-loading coupons for purchases at reduced prices, or tickets presented as Matrix barcodes used by the merchant to track discounted purchases.

A replacement for gift cards (transferring the cash value to the client buyers CPS bank account) and special offers where use of a particular venders credit card enables the purchase of gasoline at service stations that are part of the same financial entity, as an incentive to do business with both; this function can be replicated using the CPS Network. There are also special purveyors of gasoline that advertise reduced prices to their memberships; these memberships can also be supported over the CPS Network. Store loyalty cards are supported by the CPS system to keep track of in-store benefits like a free product for every ten purchased, without the expense of a separate network based upon the credit card payment system that is an expense to the merchant and customer.

“Pull” ads may also be a part of the CPS offering. The CPS offers business development services. All service offerings go through CPS as a means to limit nefarious activity associated with service offerings by third parties Merchants may enlist a CPS service to market their offerings. Service providers can offer goods or services

CBs can have additional selectable interfaces to support service offerings that enable browsing merchant ads in search of a particular good or service. This could be a search for a particular type of restaurant or a discount offered by a merchant. A key aspect to all these offerings is the mechanism to pay for them all using the CB.

Returning to the Figures, FIG. 1C illustrates an example of a block diagram of the CPS according to one embodiment. In this example, FIG. 1C starts after the user of a client buyer (CB) 50 has presented items to purchase to the client seller (CS) 54, and the CS 54 has generated a total amount due. The user of the CB 50 selects the CPS application to observe the dollar amount due by presenting the CB 50 to the merchants NFC reading device in the CTIM to create a secure communication path 31 to the CS. Items 60, 61, 62, 63, and 64 describe the features associated with the functions required to conduct payment transactions using the CPS. First, authentication 60 of the CB 50 is established as depicted by the function 30 as applied to the CB 50. This function 60 is needed to send an authorization, via 31, or activate the “PAY button on the CB 50, by sending it, via 61, as an exclusive payment control, encrypted via 40, to the CPS Processing Center (CPC) 51.

Upon establishing the independent communication 61, and obtaining access to the CS's transaction data 63, via path 31, the CB 50 sends an authorization 64, over the independent communications 62, to the CS 54. After this, the CB 50 sends the exclusive payment control 61, over link 40, to the CPC 51, and CPC 51 directs the CPS Bank 52 to make the payment, over link 42, to the Seller's Bank 53. As a part of the authentication process, it may be necessary for the authentication function 60 to query the CPC 51, over the public Internet 34, to validate that the owner is operating the CB 50. A challenge/response test may be performed, with the results sent to the authentication function 60 over links 35 and presented (internal to the CB 50) to the CB 50 via 36.

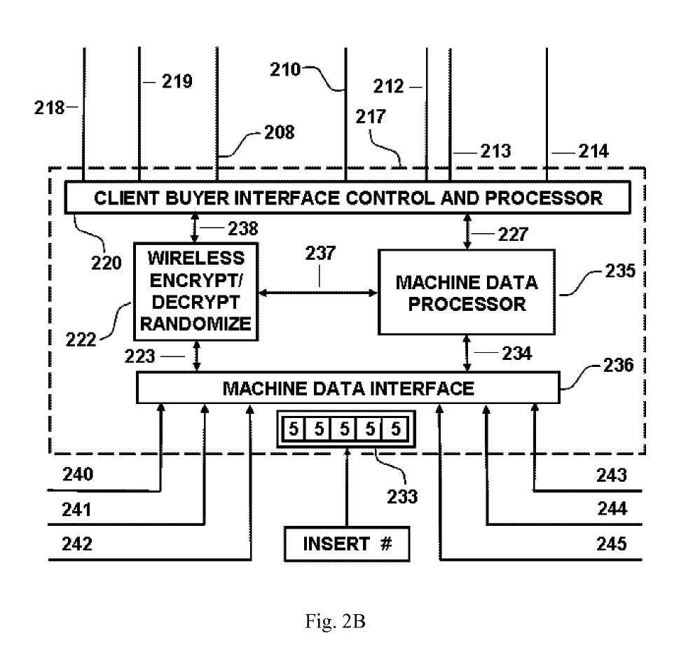

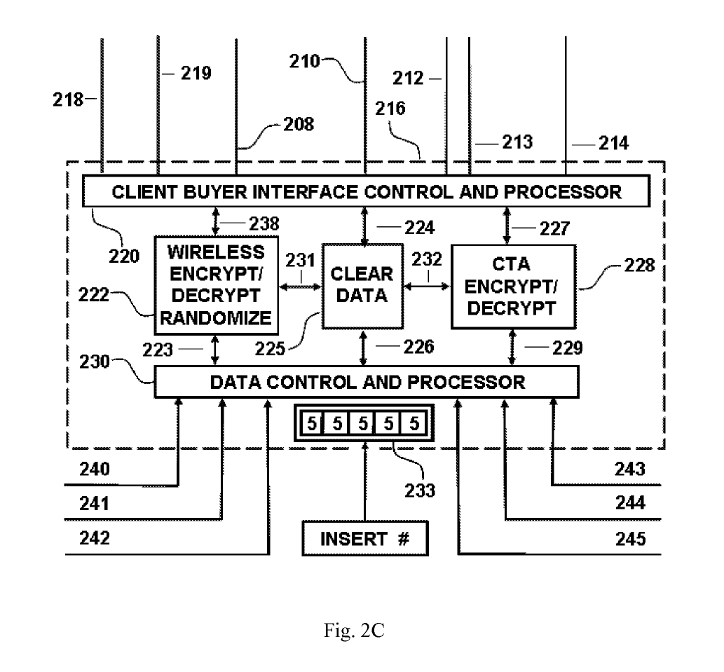

FIG. 2A illustrates a block diagram of a CPS transceiver interface module, according to one embodiment. FIG. 2A addresses CPS independent wireless two way communications using a CPS Transceiver Interface Module (CTIM) 221 to provide an interface between a CB 200 and client sellers (CS) 1000. Communications may be over NFC, if available, and/or secure WiFi and Bluetooth. Protocols used in these transmissions preclude attackers from communicating over CPS links.

The wireless CTIM 221 has an associated processor 215. The processor 215 may have two versions: one is a vending machine processor 217, and one is an in-store merchant processor 216, which works in conjunction with a CPS Terminal Application (CTA) 700. FIG. 2C illustrates an example of a block diagram of interfacing with the merchants secure infrastructure using the processor 216 that is used in CTIM 221. FIG. 2B illustrates an example of a block diagram using the vending processor 217 to interface with a simple vending machine. This CTIM is nomenclatured CTIM-V because the transceiver processor 217 is used for vending applications of various types, such as indeterminate amount, as with a gasoline dispenser, item vending or dialog vending as with multi-choice ticket vending, and others.

Processor 215 may be a dual processor that may either support a vending machine or a secure merchants interface. One processor accommodates encryption/decryption, or randomizing, communications between the CB, 200 and the CTIM-V, 221. The other processor, depending upon software load, performs encryption/decryption of communications between the CTIM and a CTA, or provides the system interface between CTIM-V and the internal machines command or sensing or data gathering. The merchants interface is designed to interoperate with the CPS Terminal Application such that there are no functional changes in the existing software operating the merchant's terminal.

However, the merchant's terminal software could be revised so the CTA would no longer be needed. The physical connection between the merchant's terminal and the CTIM must be encrypted, so the revised terminal software would encrypt the transaction data and the CTIM would decrypt it for forwarding over the CPS encrypted wireless link to the CB. Authorizations would travel, in the opposite direction, over the same path to be accepted by the terminal processor. Authorizations could be from one of two sources, from a CPS bank via a merchants bank to the merchants terminal as a result of using a CPS DC, or a CB via the CTIM.

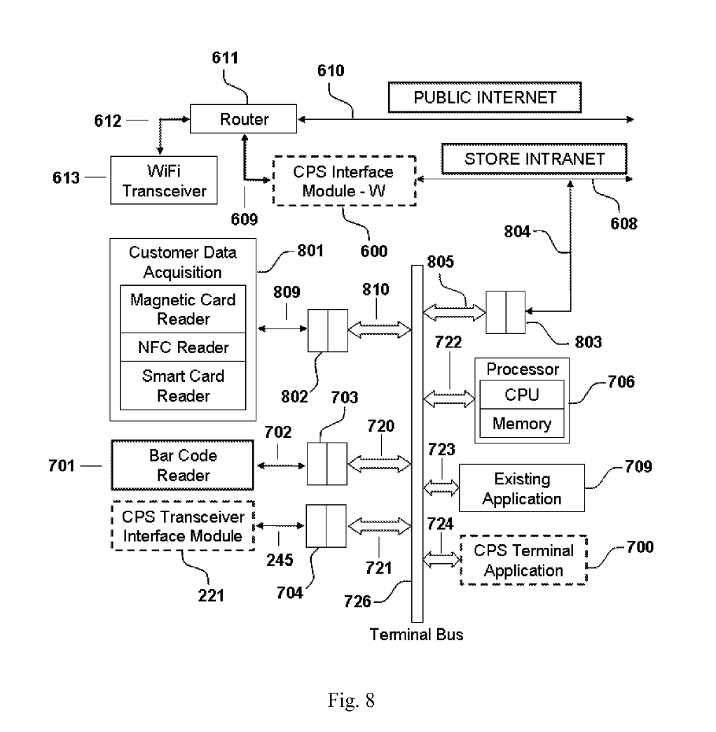

Referring to FIG. 2A, the CTIM 221 may include several electronic seller interfaces that can be tailored to each application via software supporting each of the lines 240-245. Each CTIM has a manually insertable number 233 of its terminal or vending machine number. The NFC transceiver 209 operates a short range over the air link 203 using a conventional NFC chip 209, and antenna 204. It operates as a reader to detect the presence, and thus provide a unique CB 200 identity, when the CB 200 has an NFC capability. In use, link 203 is automatically established and receives the CB's randomized Bluetooth address from the CB 200, which is passed by connection 210 to the processor for de-randomization and for forwarding, and insertion, via connection 214 into the Bluetooth address resister of the Bluetooth chip 211, which is range limited to about 10 feet, uses a directional antenna, with suppressed sidelobes 206, and quickly establishes a secure link 205, while it is still in the NFC reader zone. Upon establishing the secure Bluetooth link 205, the WiFi address of the CB 200 and a security code are passed over Bluetooth, via the processor 215 to WiFi chip 207, via the interface processor connection 208, which enables link 201 to come up secure for obtaining transaction data and providing an authorization code to the merchants checkout terminal, as described in FIG. 8 below.

If the WiFi mode of CTIM 221 to CB 200 is not working for any reason, i.e., failure of the WiFi link 201 to respond, both ends may switch over to Bluetooth operation. For this mode, the processor 216, or 217, encrypts/decrypts the Bluetooth traffic as if it were WiFi transaction data flows. This higher level of encryption is in addition to the midlevel encryption Bluetooth initially established to bring up the WiFi link. Establishing a secure Bluetooth link enables this fail over mode in the event of a failed WiFi device on the CTIM. as a gradual degradation mode instead of a cessation of the transaction. If the CB 200 has a failed WiFi capability, it would not be able to send the PAY message, however subsequent purchasers would pick up the transaction because the previous three transactions collected by the next CB and are forwarded to the CPC insure sellers are paid, in the event of a CB smartphone malfunction.

In some circumstances, where uniquely identifying the CB 200 using NFC is not an option because the CB 200 is not NFC capable, there are other ways to enable the specific CB 200 to establish the CB 200-CS 1000 wireless link. Limiting the Bluetooth range to between about ten feet, and reducing the beamwidth, reduces the population of CBs that might be standing in front of the checkout terminal's CTIM Bluetooth beam. With a person standing behind the CB 200, the CTIM Bluetooth transmitted energy that is not received by the CB 200 is absorbed by the person, to further isolate the specific CB 200 attempting to performing a pairing transaction. In the event there is still more than one CB 200 transponding, the CB 200 may request that the user of the CB 200 insert either the terminal number or the dollar amount manually. If only one CB 200 responds, with the correct answer, then the address of purchasing Bluetooth is established, and Bluetooth may now come up as encrypted link 206 to facilitate establishment of secure link 201 by passing the WiFi address and a security key.

In FIG. 2C, the wireless interface processor 216 is capable of providing secure wireless communication for either of the wireless links 201, 203 or 205 using the processor 222, and flow controlled data over 223 and 238. The CTIM 221, processor 216, using encryption engine 228, and flow controlled data, over 227 and 229, also supports encrypting the physical connection, line 245, between the CTIM and the CTA, via interface 704, and connection 721 to 726 and the Checkout terminal's CTA. The CTA encrypts/decrypts this traffic to provide a secure connection for transaction data or to insert an authorization message onto the terminal bus 726.

Movement of data between the encrypted terminal data, arriving on line 245 and the CB encrypted wireless link 201 or 205 is performed in the physically secure space 225, via connections 231 and 232. CTA data is decrypted by 228 and sent, over 232 to location 225, where it is pipelined, via 231 to the encrypter 222 for sending over secure link 201 or 205. In the event data arriving is plain text, such as a venue selection list, then it is routed to the randomizer function of 222 for broadcast by 201 or 205. In the event of a WiFi device failure in either the CB or the CTIM, the wireless communication encryption support switches to the Bluetooth link 205, and proceeds with the transaction.

Protecting the security of the wireless links and the physical connection between the CTIM and the merchant's terminal 245 may require a CPS encrypt/decrypt 222, and a merchant's encrypt/decrypt 228. A message from the CB 200 is decrypted by 222 and presented to a clear data interface 225 over connection 231. Under control of the processor 220, the traffic 232 is encrypted by 228, and sent via connection 245 to the merchant's terminal interface 704.

FIG. 2B depicts a vending machine version of the interface control and processor, as CTIM-V, address storage of previous transaction data, the role of 227 and how 235 deals with machine data, it is it is “in the clear” and delivered via 237 to be randomized and sent, over 238, via the outbound interface control, to the CB 200.

In an embodiment, FIGS. 2B and 2C could be the same physical CPU board with a different software load to produce the machine data version of the processor, 235. In this case, the available connections 240 thru 245 provide for a machine specific sensing and data transceiving. These inputs operate over a machine data interface 236, then can be interpreted via software. Nominally, interface 245 would be the interface to the DAX VDI machine status data, in the item vending mode, or in the dispensing vending mode, a control communication 241 is the dollar amount of a selected item to vend, 242 is a possible invoice number, 243 is a “do vend” command sent from the CTIM upon obtaining a valid authorization, 244 is a “machine did cancel” and 240 is a did vend signal when working in the vending mode.

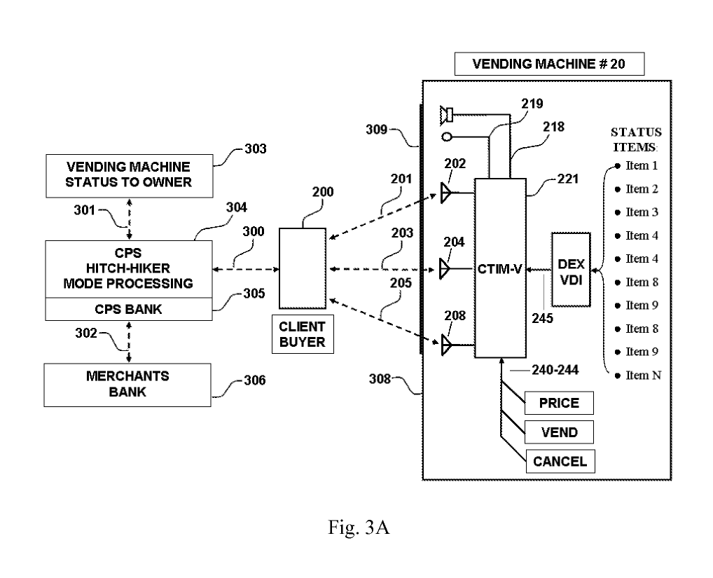

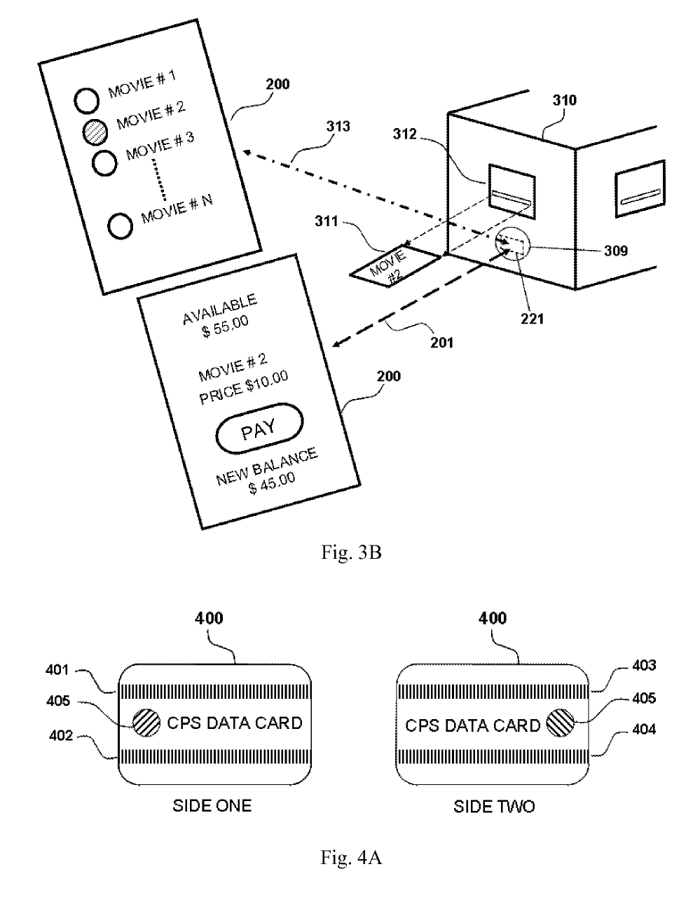

FIG. 3A describes use of the CPS in support of a conventional item vending machine, or a multi-choice application, where the internal process of the machine does not require cryptographic security. A multi-choice vending application could also operate in the hitch-hiker mode.

More specifically, FIG. 3A illustrates a block diagram of the CPS making an item type vending machine purchase in an area not served by commercial communications. This may require communication via the CTIM-V 221 using processor 217. Purchasing an item is based upon a promise to pay by a CB, which requires a secure communication and payment system.

For this example, all items have the same price and the customer selects a brand button on the vending machine 308, for the item to be purchased. The client buyer is presented to the NFC target space and, using the sequence described in FIG. 2A, quickly comes up in secure communications.

The price, as displayed on the machine, and sent randomized, via the processor 217, to the CB 200. The CB 200 owner selects the PAY button which sends an encrypted authorization, and transaction data about the CB 200, to the machine over link 201 to the CTIM-V, which sends a vend signal over connection 243. The purchase is based on a promise to pay, i.e., passing an authorization code from a representative of the CPS, the CB 200. When the CPS purchase is based on a promise to pay, the operation is referred to the “Hitch-Hiker” mode because the notice of a sale is carried by the CB until it can be transmitted to the CPC, from there, the payment to the merchant follows.

As soon as that transaction is completed, the CTIM sends all the transaction data, including that of a successful vend, along with the machine owners transaction data, back to the CB via link 201. In addition, a record of the previous three transactions is also relayed to the CB via 201. These are very short messages, and are almost instantly transported over WiFi link 201. As with FIG. 2, if, for any reason, the WiFi link is not functioning, the interface switches to conducting the data exchange over Bluetooth 203. In the event Bluetooth has also failed, the transaction can be carried as encrypted payloads over the NFC link 205, and still be at the same level of Cryptographic security, by constantly reloading the NFC tag on the CB, if so equipped.

DEX VDI data is obtained by the CTIM-V via the connection 245, and is forwarded via WiFi link 201 to the CB. Later, when the CB 200 has access to commercial communications, all the transaction data for four previous purchases and all the DEX VDI data is forwarded by wireless link 300 to the CPS processing center 913 which has a section that recognizes and processes the hitch-hiker mode 304, which checks to ensure all four purchase transactions are accounted for, so as to insure payment from all four CB's that is due to the vending machine owners bank 306. Separately, per the address programmed for that owner, stored in the CTIM-V 221, and forwarded to the CB 200, via link 201, DEX VDI data is sent over wireless link 300 by CB 200 to the hitch-hiker processor 304, and then over Internet connection 301 to the machine owner 303.

The CPS processing center 304 directs the CPS bank 305 to pay, via connection 302, the vending machine owners bank 305. The DEX VDI machine status data is assessed so as to not overly duplicate updates, by both the CTIM-V 215, and the hitch-hiker processor 304, and, when appropriate, forwards DEX VDI status to the vending machine's owner.

For the case where the smartphone is not equipped with NFC, the CB user selects “VEND” mode and enters the machine number 20 into the operator interface. In this mode, WiFi sends a precise length broadcast signal that contains the number 20. Now the CTIM-V has the WiFi address of the CB, and responds with the number 20. Now the CB has the WiFi address of the CTIM-V, and responds with the CB's 200 Bluetooth address, over link 201, which is inserted into Bluetooth device 211. Now Bluetooth link 205 can come up in the secure mode and pass an encryption code to establish a secure WiFi link, 201, and the purchase process can proceed.

The panel 309 on the front of the vending machine 308 is transparent to radio frequencies and accommodates a multicolored light 219 and sound device 218 as a status indication during the purchase process.

It should be noted that the CTIM-V is able to provide a fixed discount on the price of a drink in recognition of the cost savings to the seller because of CPS forwarding DEX VDI messages to the seller for free.

FIG. 3B illustrates and an example of the CTIM-V and processor 217 used in FIG. 3A to support a more complex two way communication operation using communications of randomized data 313, that will be presented as plain text messaging on a display, such as the multi-item venue in a movie theater. The secure communications start up sequence is the same, and all transaction data for each purchase are stored on the CTIM-V. Similar to FIG. 3A, the CB 200 also downloads the previous three transactions and retains its own transaction data, for later transmission to the CTIM over any access to the Internet, as described above.

A movie theater list of available moves is transmitted by the CTIM-V, over WiFi or Bluetooth, as a randomized data 313 broadcast, depending upon the scale of the open space in the vicinity of ticket selection and purchase. For security reasons, encryption is only used in the process of transmitting data associated with transaction data, an authorization or payment transmission. Any other data, such as a message, displayed for reading on the CB, is randomized by CTIM-V and de-randomized by the CB.

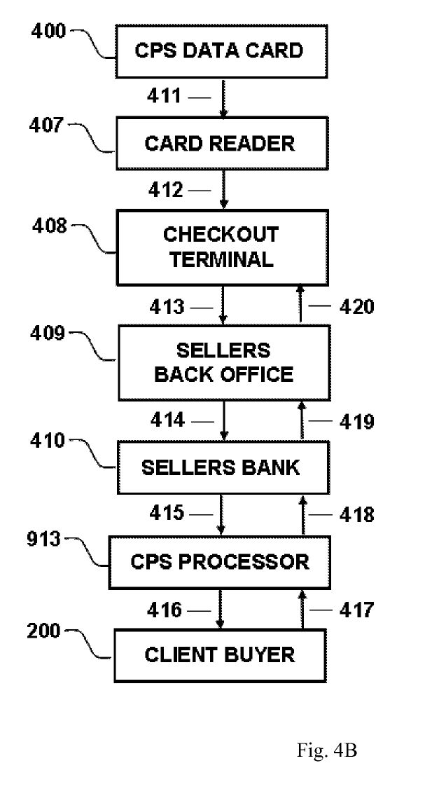

For access to a movie theater, there are two possible modes of operating. One in which movie selection, and ticket delivery, is performed by clerk and the CB 200 pays the posted price, as an in-store purchase, described in FIGS. 4 to 8. The other mode, as illustrated in FIG. 3B, is more automated, as with a ticket dispensing kiosk. The movie theater provides a list of movies, and price, as an input to the processor 217 over input line 245. This list is sent as randomized data 313 by the CTIM-V over WiFi, 202, or Bluetooth, 206, and de-randomized by the CB 200 for display on the CB 200. The CB 200 user may select a movie. Upon presenting the CB 200 to the NFC target space, the movie selection is transmitted, as randomized 313, and de-randomized by processor 217. Using the procedure described in FIG. 3A, the CTIM-V WiFi comes up secure, and provides the merchant's transaction data to the CB. The CB provides an authorization code, and CB transaction data, to the CTIM-V. All this transaction data is stored on the CTIM-V and on the CB 200. The movie selection is sent to the printer, which prints out, and dispenses the appropriate ticket 311. Subsequently, the CB 200 sends a PAY message to the CPC. Again, the operative mode for both FIG. 3A and 3B is a promise to pay if the seller will provide the good or service to the CB. Also, as described in FIG. 3A, the CB downloads the previous three transactions stored on the CTIM-V for forwarding along with the present transaction, to insure the merchant is paid in the event of a missing PAY message associated with one of the purchases listed. A missing PAY message also starts a security investigation regarding the CB that did not send a PAY message, or the previous three messages.

FIGS. 4A and 4B illustrate an example of the CPS Data Card 400 and the process of using the CPS Data Card (CPS DC) 400, for the purpose of obtaining the merchants transaction data needed to enable the placement of an authorization and making a payment transaction.

FIG. 4A depicts a data gathering card 400. It has magnetic stripes 401-404, so it may be swiped in several orientations, and it has a passive tag NFC chip 405. Both identify the CPS client ID number and other relative data needed for a payment transaction. The CPS client number, as recorded on the card, is not the same as used within the system, instead a non-public randomizing sequence is used to generate the client number on the card. The CPS processing center de-randomizes that number to obtain the actual CPS client ID number. This is to avoid providing the CB's ID number in the clear to a curious card reader.

Other distinguishing characteristics of the card 400 are that, while the format appears to be the similar to a standard credit card, how it performs its function is different. Use of the card is not an authorization. There are no credit card numbers printed on the card, and only a small group of numbers, or letters, printed on the card so a client can recognize their card. Its use gathers all the merchant transaction data needed for a payment transaction, and binds this data with the buyer's data on the card. This data is sent as a message to the address on the card, usually to an “Issuer Identification Number” (IIN). In this case it is delivered to the CPS bank. Upon decrypting by the CPS bank, it is seen to be a CPS message, so it is forwarded to the CPC. At this stage, the CPS has the address of the CB 200 and forwards all the data that buyer needs to select the PAY button on the CB 200.

Most of the data on a credit card is encrypted by the credit card reader. Only the IIN used for routing the data, and four digits of the credit card number, are not encrypted. In addition, there is a substantial amount of encrypted discretionary data; sufficient to provide all the data management features used by CPS.

FIG. 4B describes the chain of data flows when a CPS DC 400 is swiped at a card reader 407. When swiping the CPS DC 400, CB data 411 is transferred to the card reader. The card reader partially encrypts, and sends the data 412 to the checkout terminal 408. In some cases, it may go directly to the back office 409 or to the sellers bank 410, but for this example it is forwarded by terminal 408, via connection 413, to the sellers back office 409. A “back office” could be incorporated into a checkout terminal, or located at a remote facility. Here, it arrives via connection 414, at the sellers bank 410 which routes it, via 415 to the CPC 913. From there, the CPC sends a message to the CB 200 via the Internet link 416. When the information provided to the CB is in order, the CB sends a PAY command, via 417, to the CPS processor 913 which causes the CPS processor to instruct the CPS bank to send an authorization 418 to the sellers bank 410. This authorization code, and related data, such as invoice number, etc., is forwarded, via 419, to the sellers back office 409, and from there to the merchants terminal 408 via connection 420, where it is printed on the receipt so the customer may depart.

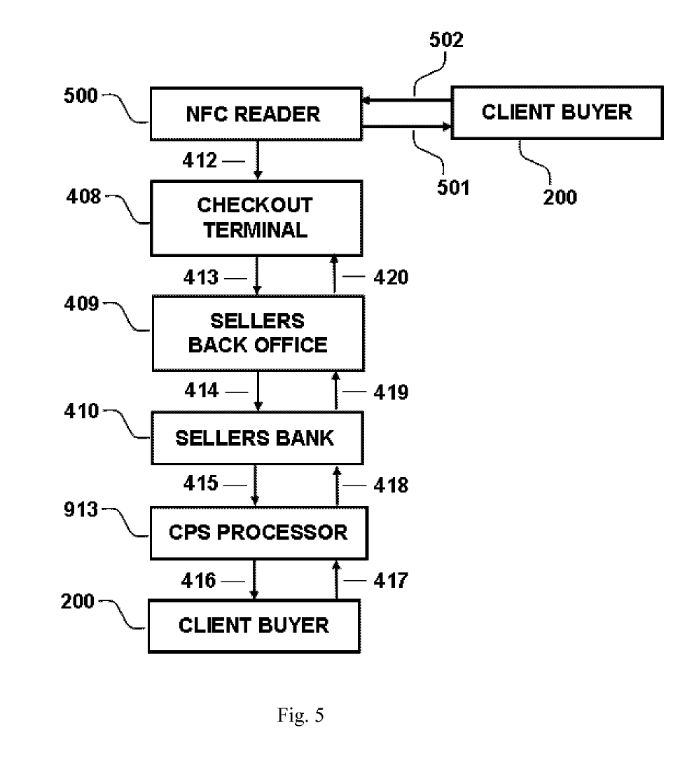

FIG. 5 illustrates an example of a block diagram that presents a NFC enabled CB 200 to an operational NFC reader 500. The NFC device in a CB 200 has a protocol that distinguishes it from the NFC tag on a CPS DC 400. This is important to initiate the next step in the payment processing sequence. A CPS DC 400 indicates the buyer has a conventional cell phone, which causes a phone call to the buyers cell phone with a spoken message describing the transaction to elicit a PAY indication from the cell phone. For a CB with a smartphone, the process is automated, and the buyer need only select the “PAY” (or cancel) button.

NFC readers 500 may periodically query for the presence of a NFC device, using link 501. If one is present, data from any CB 200 or any card 400 is read as data 502. The card reader partially encrypts, and sends the data 412, to the checkout terminal 408. It is forwarded by terminal 408, via connection 413, to the sellers back office 409. Sent by the back office, over 414, to the seller's bank 410, the bank routes all credit card traffic to credit card processors. The IIN causes CPS traffic to be routed the CPS bank, as a closely coupled intermediary to the CPC 913, via data path 415. The CPC 913 sends a message via 516 to the CB 200. The CPC 913 sends a message to the CB 200 via the Internet link 416. When the information provided to the CB 200 is in order, the CB 200 sends a PAY command, via 417, to the CPC 913, which causes CPC 913 to instruct the CPS bank to send an authorization 418 to the sellers bank 410. This is the same path 419 traveled by a credit card authorization message, so the flow is no different.

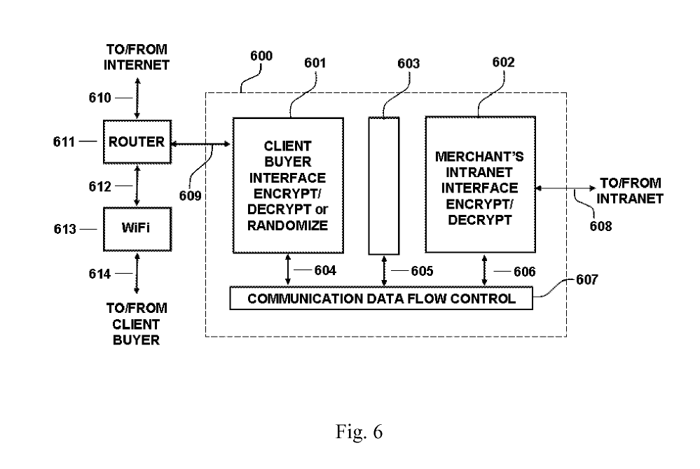

FIG. 6 illustrates an example of the CPS Interface Module (CIM-W) 600, for an in-store WiFi situation, which works in conjunction with the CPS Terminal Application (CTA) 700, to obtain transactional data from and provide an authorization, via the terminal bus 726, to the CS 1000. The CIM-W 600 establishes a secure WiFi communication link 614 with the CB 200. Router 611 is connected, via 610, to the public Internet, via 612 to the WiFi transceiver 613 and, via 609, to the encryption/decryption engine needed to secure wireless link 614. Data to/from the CB 200 is encrypted/decrypted by the engine 601 to present data, via path 604, and 605, in the clear, in 603, to merchants Intranet interface 602, via path 605 to path 606, which is re-encrypted/decrypted by and sent via the sellers Intranet 608 to the path 804 to terminal bus for communicating with the CTA 700 installed in the merchants terminal. To ensure integrity, data traveling from the CB 200, to the CTA 700, leaves the CIM-W 600, via encrypt/decrypt engine 602, encrypted and is addressed to the CTA 700, which decrypts the message that was originated by the CB 200, such as an authorization message. Data from the CIM-W travels in a reverse path to the CB 200, such as when sending CS 1000 transaction data.

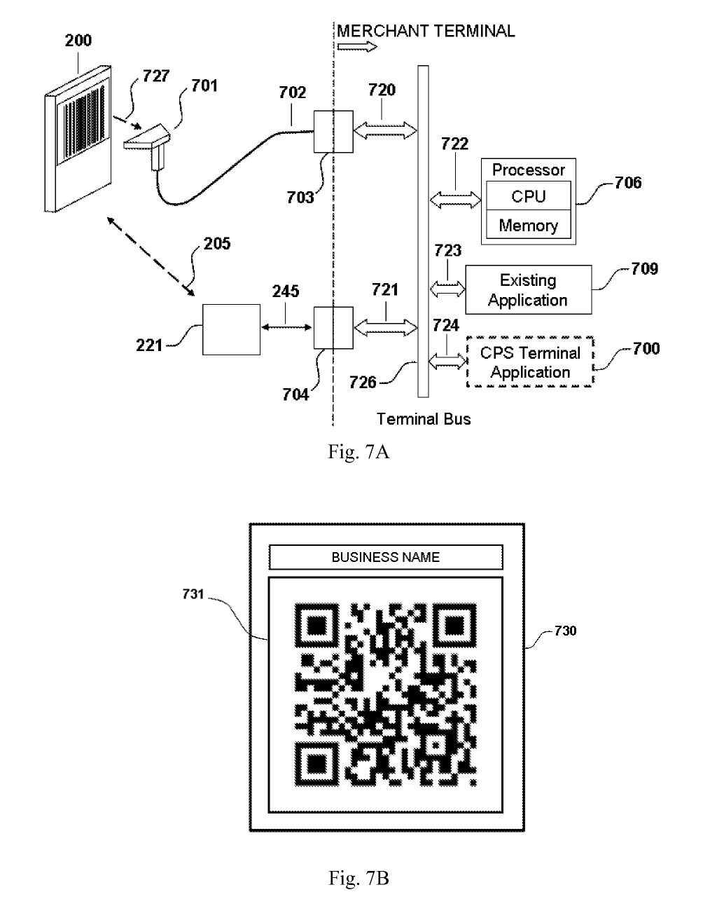

FIG. 7A illustrates an example of a means to uniquely identify the CB making a CPS purchase. FIG. 7B is CPS rural seller's invariant transaction data capture, to enable authorization and payment.

FIG. 7A depicts the relationship between the CB 200 and the CTA 700, when no other technical means is available to uniquely identify the specific CB 200 that is making the purchase, by using a Universal Product Code scanner 701 to read the bar code of the CB's address 727. Scanner 701 converts the bar code to digital data that is placed on the bus 726, via a USB or RS232 interface 703, and connection 720. The bar code 727, is passed by connection 702 to the interface 703, and placed on the bus 726 via connection 720. When the address is passed by the CTA 700, to the CTIM 221, the Bluetooth address of both ends of the link 205 are known and the Bluetooth comes up encrypted and progresses, as previously described, to secure the WiFi link 205. If the sellers environment has only a CIM-W module, and no CTIM 221, the WiFi address is passed; with both addresses known, and the WiFi link can then establish a secure link 614.

FIG. 7B depicts the placard 730 that can be provided, for example, to a rural seller wishing to be a client seller on the CPS network. It contains the seller's transaction data on a matrix barcode 731. Matrix barcodes are quickly convertible, in the CB 200, to the sellers name, CPS account number, Bluetooth address, email address and telephone number, etc. It, also, can be displayed randomized, and de-randomized by the CTIM.

First, the CB puts the smartphone into the Rural mode, causing a search for WiFi or other wireless communication signal. The rural mode works where there is either a seller with Bluetooth direct connect, i.e., without the need for other communications, or there is free WiFi or other commercial wireless communications available.

Rural sellers join CPS to process their cash transactions. They receive a “CPS Sellers Data” placard they may either present to a CB 200, or post, for photographic image capture and fast conversion to characters sufficient to provide the sellers CPS account number, email address, Bluetooth address and telephone number. To purchase, the CB user must enter the dollar amount into the application that binds the scanned image to a numerical entry. When sufficient funds exist on the CB, the customer selects the “PAY” button. This causes the issuance of an authorization code that is bound to the matrix barcode data and dollar amount. If the seller lists their Bluetooth address, the CB 200, which has the sellers Bluetooth address, instantly pairs, goes secure, and sends an oral confirmation of the dollar amount and the authorization code to the seller's smartphone.

In addition, the CPC sends this data to the CB over a secure link. If the Bluetooth direct connect mode was used, the CPS sends an email to the seller confirming the sale, listing the dollar amount and providing the authorization code. The CPC has all the transaction data needed to insure payment to the merchant's bank.

In some embodiments, CTA may requires two different encryption algorithms, one as a trusted agent on the merchants Intranet, and one as the other end of the secure physical link with the CTIM.

FIG. 8 depicts an example of the CPS modules that may be employed with a merchant's terminal, according to one embodiment. Both the CTIM and the CIM-W require a CTA installed in the terminal to communicate to/from the terminal bus 726. The CTIM 221 communicates with the terminal via 245 to interface 704 which supplies data to and extracts data from, the terminal bus 726 via connection 721. The CTIM is a physical module that is mounted in a similar location as a card reader so it is convenient to present a CB 200 to be “read.” Its function is to provide an interface between a CB 200 and the bus of the merchant's checkout terminal 726. The CIM-W 600 is an interface between a CB 200 that is communicating with the existing free WiFi 613 service of a merchant and the merchant's Intranet 608 that has physical connectivity with the merchant's terminal via 804, interface 803 and connection 805 to the bus 726. To minimize cabling, CIM-W 600 may be co-located it with the router 611.

The CIM-W 600 may function to provide an interface between the CB 200 and the terminal bus 726. Stores with existing free WiFi may prefer not to use a CTIM. The expectation is that either a CIM-W 600 or a CTIM is used. Using protocols that assist in resource management so that the presence of both can be detected, if both are present, and the CB has NFC, then the CTIM becomes the interface. If the CB does not have NFC, then the CIM-W would be the interface with the bar code scanner 701 used for identifying the purchasing CB 200. Because some merchants do not use bar code scanners, and some CB's may not have NFC, the start-up sequence would revert to operating in the WiFi only mode. For the case of only the CB 200 and the Client Buyer Interface 601, both have provision, by prearranged keys, to come up encrypted once the addresses of each end are known. To establish addresses in this mode, the WiFi node 613 broadcasts the terminal number as posted on the customer's terminal. This is seen by only those CB's in the population with their CPS application running, and ready to pay. One CB 200 responds, thereby establishing addresses on each end, and the WiFi comes up encrypted to proceed with the transaction. If two respond, a message is sent to both via 614 to have both CBs 200 query the dollar amount, to be entered manually. One knows because of their proximity to the display of the total amount. If both respond with the correct amount, then a challenge is presented to both CBs to resolve an authentication issue. The solution to this problem is to repeat the startup procedure, have the clerk insert an additional random number, that is later removed, to provide a different total and shield the display so only the legitimate buyer knows the number, as does the CTA, and a connection is made with the actual CB 200. A report is forwarded to the CPC 913 of the technical data that identifies the physical device, along with the authentication results, of other CB in the event it was a prank, or the precursor of a future attack.

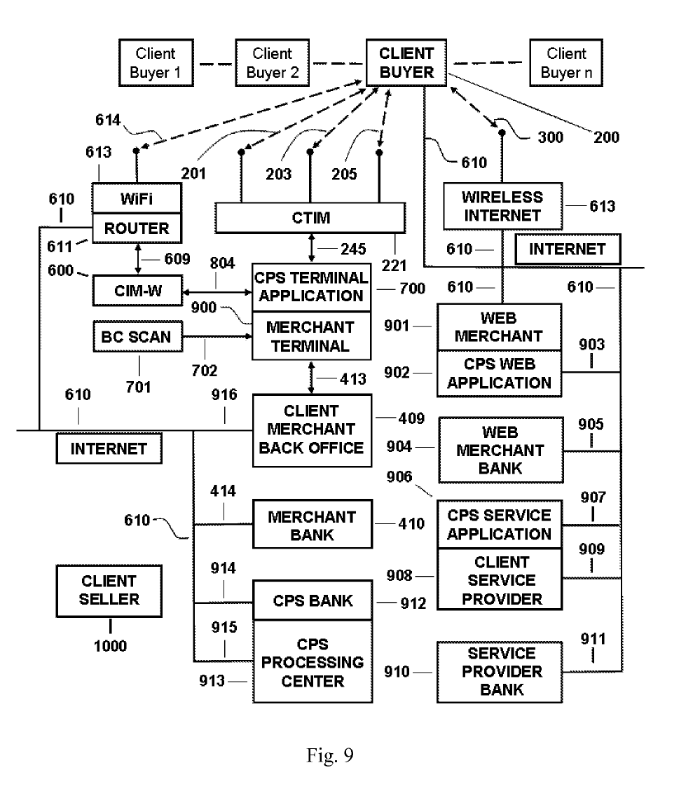

FIG. 9 illustrates a block diagram of an example of a system for purchasing from a web merchant or service providers. In this example, CPS uses the Internet protocol. Particular routed messages are called out by number. Inherent in FIG. 9 is a multiplicity of access, and creating independent communications using existing widespread short range protocols and technology has substantial value.

FIG. 9 covers the span of CB 200 utility for purchasing and payment procedures to pay CSs 1000, Client Web Merchants (CWMs) 901, and Client Service Providers (CSPs) 908. As mentioned above, the CB 200 could be a wireless handheld or a desktop communicating over a wireline 610, or wireless connection 300, to the Internet. The CWM 901 and CSP 908 have the CPS applications installed on their payment transaction servers. The CWM 901 uses a CPS Web Application (CWA) 902 and the CSP 908 uses CSA 906. While not illustrated in FIG. 9, features, such as fingerprint and voice print analysis, challenge/response, and maintaining accounting, etc., may be provided by the CB 200 while the Cloud based CPC, has more computationally intensive challenge/response tests that can be invoked from any type of mobile or desktop computer so as to determine if the owner is validated or the application should be turned off by the CPC to protect the funds of the account owner. The challenge/response capability on a smartphone supports the CB 200 ability to operate as a stand-alone device over independent communications.

By swiping a CPS Data Card to make a purchase, the CB 200 and merchant transaction data is entered into the Internet and arrives at the CPS Bank, via message on 914, and is internally forwarded to the CPS, 913, for processing. Directed by the CPS 913 this results in the CPS Bank 912 generating an authorization, sent over path 914, via 414, to the Merchant's Bank, which forwards this authorization, over 414 to the Merchants Back Office 409, over 916 and is forwarded, over 413, to the Merchant's terminal 900, as a condition for release of the customer. After the CB 200 departs with the purchase, the CPS Bank 912 sends the funds, via 414, to the Merchant's Bank 410.

For a vending machine purchase, the merchant's terminal 900 is the vending machine. In the case of a vending machine, the CTA 804 is a simple attachment to the internals of the machine to control, feedback and acquire data, such as DEX. The CB 200 establishes secure communications using links 201, 203 and 205, or as an alternative, depending upon circumstance, using 201 and 205. After receiving transaction data from CTIM-V 221, over link 201, the CB 200 sends an authorization to CTIM-V, 221 which vends the product and stores a record of the transaction. A record of the transaction is also stored in the CB 200, and also forwarded to the CPS 913 over connection 300 to 915. The CPS Bank then sends funds, via 914 and 414, to the Merchant's Bank.

Purchases using a CTIM 221 and a CTA 700 are used for a large volume, in-store merchant. The CTIM 221, over a combination of links 201, 203, 205, establishes secure communications to obtain present transaction information obtained from the CTA 700, over connection 245. In the CTIM 221, this is added to the invariant merchant transaction data stored in the CTIM 221, and sent to the CB over link 201, or possibly link 203 or 205 in the case of needing back up communications. Upon the CB 200, sending an authorization via one of those wireless links, to the CTIM 221, and receiving a communication receipt affirming its reception, over the same links, the CTIM 221 forwards this message, as encrypted, to the CTA 700 which inserts the authorization onto the terminal bus to enable printing a receipt to complete the transaction, the CB 200 part of the purchase authorization sequence is satisfied. Next, CB 200, over link 300, using the Wireless Internet access device 613, sends a “PAY” command and transaction data message, including several previous transaction records, to the CPC 913, over the Internet 610, via path 915. The CPC 913 directs the CPS Bank 912, to send, over path 914, payment to the Merchant's Bank 410, over path 414.

CB 200 purchases using a “free WiFi” 613, over link 614, requires an interface module through which a CB 200 can communicate with a merchants terminal; this requires using dual encryption data exchange module CIM-W 600 and a CTA 700, which are connected by Intranet path 804. This way, the CB 200 can communicate to the secure internals of the merchant's terminal to obtain transaction data and send an authorization over link 614. Both the CB 200 and the CIM-W 600 retains this transaction data. The CB 200 retaining record of this transaction, and downloading several previous transaction records from the CIM-W 600, forwards the “PAY” command for this transaction, and several previously stored transactions, via link 300 to the CPC 913, over path 915, via the public Internet 610. The CPC directs the CPS Bank 912 to send, over path 914, payment to the Merchant's Bank 410, over path 414.

The Bar Code Scanner 701 is a local merchant service, via connection 702, to identify that specific CB 200, by passing its Bluetooth address to the CTA 700 which recognizes a barcode read, extracts the number, as present on the terminal bus, and forwards it to the CTIM 221, over connection 245, as the means to establish a secure communication between the CTIM 221 and that specific CB, 200.

Mobile Client Buyers 200 can access Web Merchants 601 and Service Providers 908, over a wireless link 300. A wire line Internet connection 610, or a Wireless Internet interface link 300, supports the desktop CB 200. Mobile and desktop displays may have a similar look and feel.

Purchasing by desktops using the CPS is similar to the mobile operations discussed above, with one exception: the sequence of message sending may be rearranged to insure that both the necessary messages are sent before the customer observes that the transaction is complete. These must be sent one after the other; first the authorization, with a TCP and application confirmation, and then the PAY command is sent. Unlike smartphones, customarily on for at least a business day, desktop computers may be turned off immediately after making a purchase. It is important to insure that CPS software does not release the CB until the transaction is complete. Protocols in use indicate that the CB is a desktop, and thus indicates this mode to the CPS application at the sellers Web site.

When searching a CWM 901, or service provider 908 site, the browser session is not encrypted. When the decision to buy has progressed to selecting “pay using CPS,” a secure connection between the CB, over the Internet 610, and the sellers CWM, 901, or CSP 908, also connected to 610, is established over which the sellers transaction data is sent, by the CPS application running on the sellers server, to the CB 200 browser, via communication over 610, or wireless 300.

Once the CWM 901, or CSP 908, secure browser session is obtained with the CB 200, while retaining that secure link, the CB 200 establishes a secure email session with the CPC, over path 915 and forwards the “PAY” command, together with the transaction data. During this session, the CPC instantly responds with a receipt that it has the PAY command and transaction data. Once the receipt is received, the CB 200, using a browser, resumes communication with the server application to forward the authorization. Continuing this session, the CPS application on, either the CWA 902 or CSA 905 server that receives the authorization, activates two messages. The first message sends receipt back to the CB 200 over 610. The second message, having received the authorization, directs the CPS application to send a message to the sellers application to proceed with acceptance of the order. The server sends a message back over the browser session over 610, thanking the patron for their order, which permits their computer to be turned off.

For a web site, any payment engine, or parts thereof, may reside within, and be integrated into, the sellers processes, as credit card processes are today. Seller's web sites may have a CPS application installed if deemed more cost effective than the existing payment methods that reside as applications on their servers.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

I Claim:

1. A cash payment method, comprising:
receiving, by a client buyer, a seller identification and transaction data from a seller in a transaction; and
sending, by the client buyer, an authorization to the seller,
wherein, upon receipt of the authorization by the seller, the transaction is completed.

2. The method according to claim 1, further comprising automatically sending, by the client buyer, a pay command to the cash payment system (CPS) bank of the client buyer, the pay command directing the CPS bank to pay the seller.

3. The method according to claim 1, wherein the client buyer comprises at least one of a mobile device, smart phone, tablet, laptop, or desktop computer.

4. The method according to claim 1, wherein the sending of the authorization to the seller comprises sending an authorization that does not include personally identifiable information of a user of the client buyer.

5. The method according to claim 1, further comprising authenticating a user of the client buyer prior to the sending of the authorization.

6. The method according to claim 1, wherein the receiving and the sending are performed via a two-way secure communication interface.

7. The method according to claim 1, wherein the seller comprises a vending machine.

8. The method according to claim 7, wherein the receiving comprises receiving the seller identification, the transaction data and machine status data and sending, by the client buyer, an authorization to the seller performed via a two-way secure communication interface.

9. The method according to claim 1, wherein the receiving comprises capturing and processing an image of a data placard that contains receiving the seller identification and the invariant transaction data.

10. The method according to claim 1, wherein the receiving comprises using a data gathering card to obtain the seller identification and the transaction data.

11. The method according to 5, wherein the authenticating comprises using private information and using a biometric measuring capability of the client buyer to authenticate an identity of the user.

12. The method according to claim 1, wherein the transaction will still be completed even if a back office computer system of the seller goes down.

13. The method according to claim 2, wherein the pay command allows the client buyer to exclusively control a transferring of funds to the seller.

14. The method according to claim 1, further comprising performing, by a CPS processing center, processing including securely managing client buyer pay commands, accounting of business building benefits and secure payments to the seller.

15. An apparatus, comprising:
at least one processor; and
at least one memory including computer program code, wherein the at least one processor and the at least one memory are configured to control the apparatus to
receive a seller identification and transaction data from a seller in a transaction; and
send an authorization to the seller,
wherein, upon receipt of the authorization by the seller, the transaction is completed.

16. The apparatus according to claim 15, wherein the apparatus comprises at least one of a mobile device, smart phone, tablet, laptop, or desktop computer.

17. The apparatus according to claim 15, wherein the at least one processor and the at least one memory are further configured to control the apparatus to automatically send a pay command to the cash payment system (CPS) bank of the client buyer, the pay command directing the CPS bank to pay the seller.

18. The apparatus according to claim 15, wherein the sending of the authorization to the seller comprises sending an authorization that does not include personally identifiable information of a user of the apparatus.

19. The apparatus according to claim 15, wherein the at least one processor and the at least one memory are further configured to control the apparatus to
authenticate a user of the apparatus prior to the sending of the authorization; and
receive and send via a two-way secure communication interface.

20. The apparatus according to claim 14, wherein the seller comprises a vending machine, and wherein the at least one processor and the at least one memory are further configured to control the apparatus to receive the seller identification, the transaction data and machine status data and to send an authorization to the seller performed via a two-way secure communication interface.
